(19) United States
(12) Patent Application Publication
(10) Pub. No.: US 2026/0237905 A1
(43) Pub. Date: Aug. 13, 2026

(54) ANTENNA WITH MULTIPLE BANDWIDTH ENHANCEMENT TECHNIQUES

(71) Applicant: Neptune Technology Group LLC, Tallassee, AL (US)

(72) Inventor: Tan Dinh Quach, Montgomery, AL (US)

(73) Assignee: Neptune Technology Group LLC, Tallassee, AL (US)

(21) Appl. No.: 19/441,990

(22) Filed: Jan. 7, 2026

Related U.S. Application Data
(60) Provisional application No. 63/757,542, filed on Feb. 12, 2025.

(51) Int. Cl. H01Q 9/04; H01Q 5/20; H01Q 13/10

(52) U.S. Cl. CPC H01Q 9/0407; H01Q 5/20; H01Q 13/10

(57) ABSTRACT

A microstrip antenna may include a substrate with a first surface and a second surface. A microstrip patch, which may include a pair of slots and a perimeter slot, may be coupled to the first surface of the substrate. Additionally, a ground plane may be coupled to the second surface of the substrate. The microstrip antenna may provide dual resonance within a predetermined range of frequencies.

### CROSS-REFERENCE TO RELATED APPLICATIONS

This application claims the benefit of priority to U.S. Provisional Patent Application No. 63/757,542, filed on February 12, 2025, the entirety of which is hereby incorporated by reference.

### BACKGROUND

Microstrip antennas may be used in wireless communication systems due to their low profile, conformability, and ease of fabrication. A microstrip antenna may consist of a metallic patch placed over a dielectric substrate, with a ground plane on the opposite side of the substrate. The metallic patch radiates the electromagnetic waves, while the dielectric substrate provides the dielectric support and influences the antenna’s properties.

One challenge in the design and implementation of microstrip antennas is achieving desired performance parameters such as bandwidth, radiation efficiency, and gain, while maintaining a compact form factor. More generally, designing and implementing microstrip antennas includes challenges related to optimizing performance, achieving desired form factor, and considering practical constraints.

### BRIEF SUMMARY

In various embodiments, a microstrip patch antenna includes a substrate with a first surface and a second surface. A microstrip patch, which may include a pair of slots and a perimeter slot, may be coupled to the first surface of the substrate. Additionally, a ground plane may be coupled to the second surface of the substrate.

In various embodiments, a method of manufacturing a microstrip patch antenna includes providing a substrate having a first surface and a second surface, providing a microstrip patch comprising a pair of slots and a perimeter slot, where a base of the slots are defined by the first surface, where a depth of the slots are defined by a thickness of the microstrip patch, and coupling: (i) the microstrip patch to the first surface of the substrate, and (ii) a ground plane to the second surface of the substrate.

In various embodiments, an apparatus includes a microstrip antenna. The microstrip antenna may include a substrate with a first surface and a second surface. A microstrip patch, which may include a pair of slots and a perimeter slot, may be coupled to the first surface of the substrate. Additionally, a ground plane may be coupled to the second surface of the substrate.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates a microstrip antenna in accordance with one embodiment.

FIG. 2A illustrates a microstrip antenna in accordance with one embodiment.

FIG. 2B illustrates a microstrip antenna in accordance with one embodiment.

FIG. 3A illustrates a microstrip antenna in accordance with one embodiment.

FIG. 3B illustrates a configuration of a microstrip patch in accordance with one embodiment.

FIG. 4 illustrates a frequency response graph of a microstrip antenna in accordance with one embodiment.

FIG. 5A illustrates a microstrip antenna in accordance with one embodiment.

FIG. 5B illustrates a configuration of a microstrip patch in accordance with one embodiment.

FIG. 6 illustrates a frequency response graph of a microstrip antenna in accordance with one embodiment.

FIG. 7 illustrates surface current densities on a microstrip patch in accordance with one embodiment.

FIG. 8 illustrates surface current densities on a microstrip patch in accordance with one embodiment.

FIG. 9 illustrates surface current densities on a microstrip patch in accordance with one embodiment.

FIG. 10 illustrates surface current densities on a microstrip patch in accordance with one embodiment.

FIG. 11 illustrates surface current densities on a microstrip patch in accordance with one embodiment.

FIG. 12 illustrates surface current densities on a microstrip patch in accordance with one embodiment.

FIG. 13 illustrates surface current densities on a microstrip patch in accordance with one embodiment.

FIG. 14A illustrates a microstrip antenna in accordance with one embodiment.

FIG. 14B illustrates a configuration of a microstrip patch in accordance with one embodiment.

FIG. 15 illustrates a frequency response graph of a microstrip antenna in accordance with one embodiment.

FIG. 16 illustrates a method 1600 in accordance with one embodiment.

FIG. 17 illustrates a system in accordance with one embodiment.

FIG. 18 illustrates a computing system 1800 in accordance with one embodiment.

### DETAILED DESCRIPTION

Embodiments disclosed herein include a microstrip antenna (also referred to as a “printed antenna” or “microstrip patch antenna”) configured to create one or more resonant frequencies across a desired bandwidth (e.g., a range of frequencies), devices including dual-resonance microstrip antennas, and methods of manufacturing dual-resonance microstrip antennas. In some embodiments, a perimeter slot and a pair of slots may be cut into a microstrip patch of the microstrip antenna. The pair of slots may have substantially similar dimensions and/or asymmetrical dimensions. In some embodiments, the pair of slots is an E-slot. The perimeter slot and pair of slots may be cut along a perimeter of the microstrip patch. In some embodiments, the microstrip patch is in a circular shape.

In some embodiments, the perimeter slot may create the dual (or double) resonance response in the microstrip antenna. However, the dual resonance response may not be within the desired bandwidth. In some embodiments, the pair of slots may shift the dual resonance response into the desired bandwidth.

For example, a long range (LoRa®) microstrip antenna may have a requirement set by the Federal Communications Commission (FCC) to operate in the 902-928 megahertz (MHz) bandwidth. As another example, a Bluetooth® microstrip antenna may have an FCC requirement to operate in the 2.402-2.480 gigahertz (GHz) range and/or the 2.400-2.4835 GHz range. By providing the perimeter slot and the pair of slots in the microstrip patch, the perimeter slot may provide the desired dual resonant frequency responses, while the pair of slots may shift the frequencies within the desired ranges, e.g., 902-928 MHz for LoRa, 2.402-2.480 GHz for Bluetooth, and/or 2.400-2.4835 GHz for Bluetooth.

In some embodiments, the dual resonance frequency response within the desired ranges is based on a configuration of the microstrip antenna. For example, the configuration may be based on one or more of: (i) a radius of the microstrip patch, (ii) a location of a feed point (or connector) of the microstrip antenna, (iii) a thickness of the substrate, (iv) one or more dimensions (e.g., length and width) of the perimeter slot, (v) one or more dimensions (e.g., length and width) of each slot of the pair of slots, (vi) an angle of orientation of the perimeter slot relative to the pair of slots, (vii) a distance between the slots in the pair of slots, or any combination thereof. Embodiments are not limited in these contexts.

Advantageously, embodiments disclosed herein provide a microstrip antenna that is configured to exhibit dual resonance within a predetermined bandwidth. Doing so improves the performance of the antenna, e.g., via improved return loss (RL), increased bandwidth, data transfer rate, energy use, and/or communications range. For example, a device such as a meter interface unit (MIU) coupled to the microstrip antenna may wirelessly communicate data with a remote device at a wider range of bandwidths, at a higher data transfer rate, using less energy, and/or at greater distances. Furthermore, the bandwidth optimization techniques facilitate any number and type of requirements, e.g., requirements set by the FCC. Embodiments are not limited in these contexts.

Aspects of the present disclosure and certain features, advantages, and details thereof are explained more fully below with reference to the non-limiting examples illustrated in the accompanying drawings. Descriptions of well-known techniques, systems, components, etc., are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying concepts will be apparent to those skilled in the art from this disclosure. Note further that numerous aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

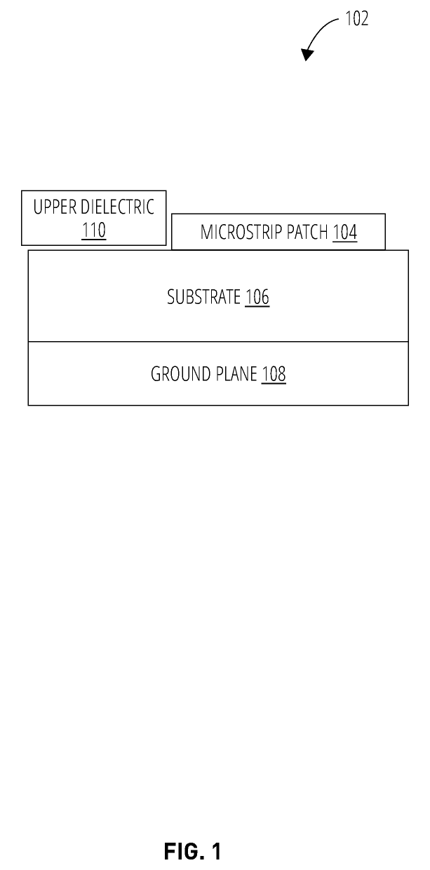

FIG. 1 illustrates components of a microstrip antenna 102 (also referred to as a “printed antenna” or “microstrip patch antenna”). As shown, the microstrip antenna 102 includes a microstrip patch 104 (e.g., a radiating element), a substrate 106, and a ground plane 108 (e.g., a metal). The microstrip patch 104 may be coupled to a first surface of the substrate 106 while the ground plane 108 may be coupled to a second surface (opposite of the first surface) of the substrate 106. An upper dielectric 110 of the microstrip antenna 102 may be air.

A microstrip antenna generally includes a patch of metal of various shapes (e.g., microstrip patch 104) on the surface of a substrate 106 (such as a printed circuit board (PCB)), with a metal (e.g., ground plane 108) on the other side of the substrate 106. A microstrip is a type of electrical transmission line which can be fabricated with any technology where a conductor is separated from a ground plane by a dielectric layer (e.g., a substrate such as substrate 106). Microstrip antennas such as microstrip antenna 102 are generally used to convey (e.g., transmit and/or receive) microwave-frequency signals.

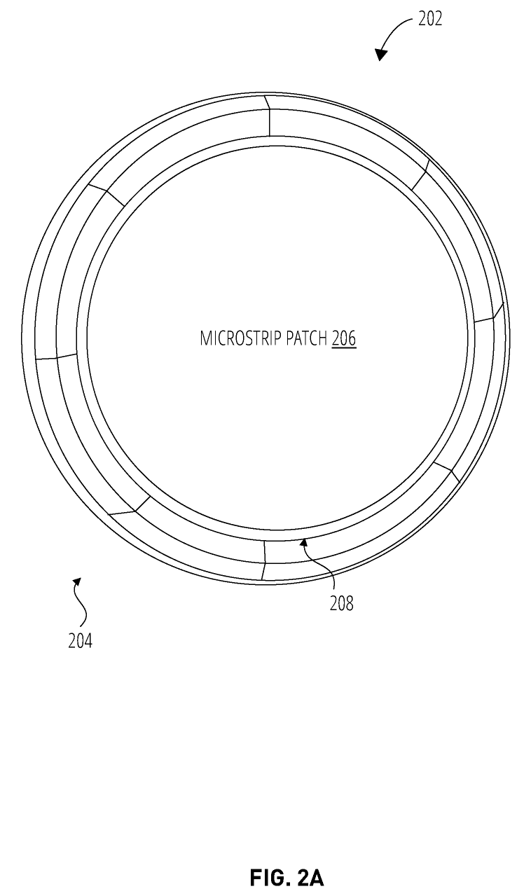

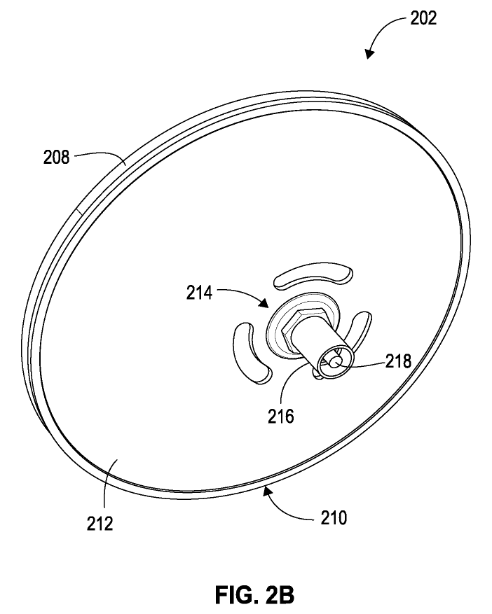

FIG. 2A illustrates a microstrip antenna 202 for transmitting and/or receiving electromagnetic waves, according to one embodiment. As shown, a first surface 204 (e.g., the top) of the microstrip antenna 202 includes a microstrip patch 206 and a substrate 208. As shown, the microstrip antenna 202 and/or the microstrip patch 206 may be in a circular shape.

FIG. 2B illustrates a second surface 210 (e.g., the bottom or underside) of the microstrip antenna 202, according to one embodiment. As shown, the second surface 210 of the microstrip antenna 202 includes a ground plane 212 and a connector 214 which includes an outer conductor 216 and an inner conductor 218. In an embodiment, the connector 214 comprises a coaxial cable connector.

As shown, the microstrip antenna 202 is in a substantially circular, flat shape. Such a configuration may be advantageous in various settings. For example, the microstrip antenna 202 may be placed on a pit lid of a meter pit, with the connector 214 extending through an opening of the pit lid. Doing so may allow the microstrip antenna 202 to be coupled to a meter interface unit and/or a metering device. The metering device may be any type of meter, such as a water meter, gas meter, and/or electricity meter. Embodiments are not limited in these contexts, as the microstrip antenna 202 may be coupled to any device to facilitate wireless communications.

The microstrip patch 206 may be any conductive element. For example, the microstrip patch 206 may be aluminum, copper, or any conductive material. The microstrip patch 206 may be any radiating element, such as a metal foil, plated metal layers, printed conductive inks, and/or thin-film deposition. The substrate 208 may be any insulator. For example, the substrate 208 may be a PCB, plastic, nylon, or air.

In some embodiments, the dielectric constant of the substrate 208 is selected to make the microstrip patch smaller, e.g., by having a high dielectric constant. For example, to allow the microstrip antenna 502 to have a small form factor, the dielectric constant of substrate 208 may be high. In some embodiments, such as for wideband wireless communications, the substrate 208 may have a lower dielectric constant (e.g., low permittivity).

The ground plane 212 may be any conductive element. For example, the ground plane 212 may be aluminum, copper, or any conductive material.

In some embodiments, the substrate 208 may be a PCB. In such embodiments, the microstrip patch 206 may be etched into a pattern in metal trace bonded to the PCB with a continuous metal layer bonded to the opposite side of the substrate 208 which forms the ground plane 212. As other examples, the microstrip patch 206 may be generated using chemical etching (e.g., photolithography and etching), electroplating, or printed conductive ink. In some embodiments, the microstrip patch 206, substrate 208, and ground plane 212 may be coupled by other means, such as being held together by an adhesive (e.g., glue, tape, etc.).

The microstrip antenna 202 may be coupled to an apparatus via connector 214. The connector 214 may be configured to couple (e.g., connect) to a cable such as a coaxial cable. The outer conductor 216 may be any type of conductor, such as a metal, and may be connected to the ground plane 212. The inner conductor 218 may be any type of conductor, such as a metal, and may be connected to the microstrip patch 206. The apparatus connected to the microstrip antenna 202 may be any type of device, such as a meter interface unit, a metering device, a computing device, a smartphone, etc. Other elements may be present between the connector 214 and the apparatus connected to the connector 214, e.g., a transceiver or other wireless communications circuitry.

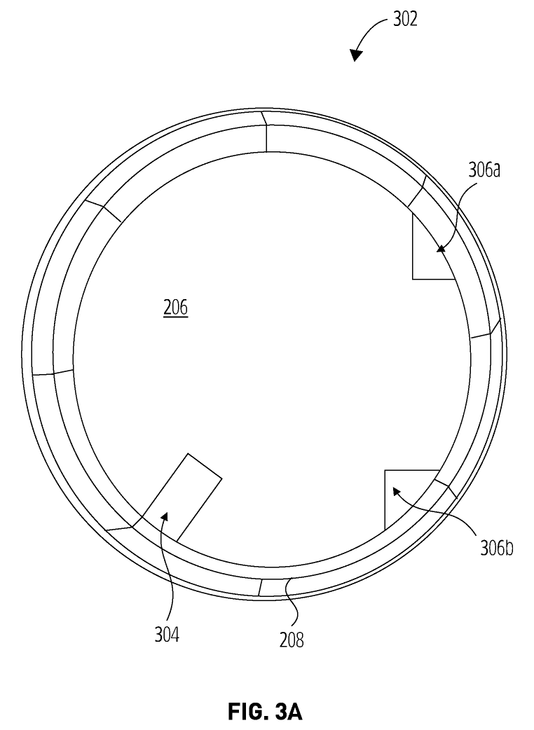

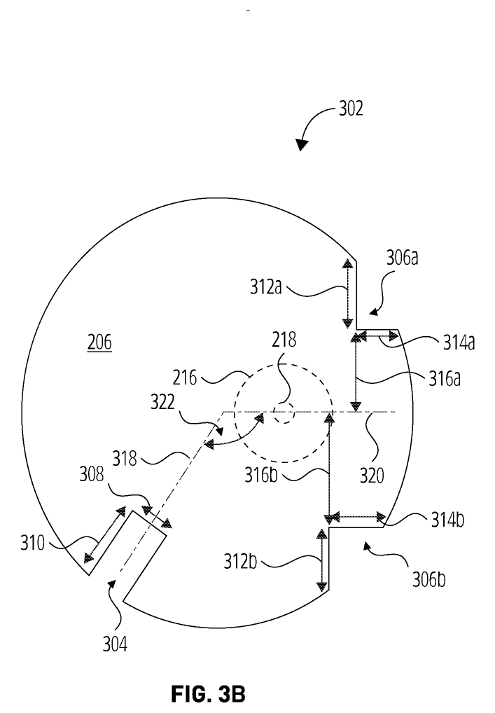

FIG. 3A illustrates an embodiment of a microstrip antenna 302. The microstrip antenna 302 includes components of the microstrip antenna 202, including the microstrip patch 206, substrate 208, ground plane 212, and connector 214 (the ground plane 212 and connector 214 are not pictured due to the two-dimensional limitations of the Figure). Therefore, the microstrip antenna 302 is an example embodiment of the microstrip antenna 202.

As shown, the microstrip antenna 302 of FIG. 3A includes a perimeter slot 304 and a pair of slots (also referred to as an “e-shaped slot”), namely e-shaped slot 306a (e.g., a first slot of the pair of slots) and e-shaped slot 306b (e.g., a second slot of the pair of slots). The e-shaped slot 306a and e-shaped slot 306b may collectively form an e-shaped slot. The perimeter slot 304 and e-shaped slots 306a, 306b are cut into (or otherwise removed from and/or not included in) the microstrip patch 206. Doing so may leave substrate 208 exposed where perimeter slot 304 and e-shaped slots 306a, 306b are located.

Conventionally, without modifications, a microstrip antenna exhibits a single resonant response. Stated differently, a conventional microstrip antenna has a single resonant frequency. Furthermore, a conventional microstrip antenna produces a single resonant response at a predetermined frequency. However, a single resonant response may provide limited bandwidth, e.g., at a specific frequency (or subset of frequencies), while other bandwidths may be desired.

For example, the LoRa bandwidth range may be 902-928 MHz. A conventional microstrip antenna may provide a single resonant frequency that is narrowband (e.g., within 910-920 MHz and/or a subset thereof), which is not capable of reaching 10dB return loss (RL) for wider bandwidths (e.g., within 902-928 MHz and/or a subset thereof). Similar limitations may be experienced in other wireless communications formats, such as Bluetooth.

Advantageously, however, the microstrip antenna 302 provides a dual resonance response across a desired (e.g., a predetermined) bandwidth. For example, microstrip antenna 302 may provide dual resonance across the 902-928 MHz range for LoRa. More specifically, the perimeter slot 304 may provide a dual resonance response for microstrip antenna 302. However, this response may not be within the desired 902-928 MHz bandwidth. For example, the microstrip antenna 302 with only the perimeter slot 304 may have dual resonances at approximately 1.2 GHz and 1.8 GHz, which is far from the desired bandwidth of 902-928MHz. As another example, providing the perimeter slot 304, without more, may provide a return loss of -4.4dB at 902MHz, far from the -10dB requirement.

Advantageously, however, the pair of e-shaped slots 306a, 306b shift the response to the desired 902-928 MHz range (and/or a subset thereof). For example, the e-shaped slots 306a-306b may shift the dual resonant frequencies lower and closer together relative to only providing the perimeter slot 304. Therefore, the e-shaped slots 306a-306b may have the effect of making the microstrip antenna 302 electrically larger, thereby shifting resonant frequencies lower. As such, the perimeter slot 304 and the pair of e-shaped slots 306a, 306b of the microstrip antenna 302 may cause the microstrip patch 206 to have different resonances. Advantageously, the microstrip antenna 302 may be included in or coupled to any type of apparatus, e.g., a meter interface unit, a metering device, a computing device, a smartphone, etc.

FIG. 3B illustrates a configuration of the microstrip patch 206 of microstrip antenna 302 in greater detail, according to one embodiment. For the sake of clarity, the substrate 208 and ground plane 212 of microstrip antenna 302 are not depicted in FIG. 3B.

In the embodiment depicted in FIG. 3B, a radius of the microstrip patch 206 is 49 millimeters (mm) and the substrate 208 has a thickness of 6 mm. The thickness of the microstrip patch 206 may be of any thickness. For example, the microstrip patch 206 of microstrip antenna 302 may have a thickness of 2.3 mm. In some embodiments, a dielectric constant of the substrate 208 of microstrip antenna 302 is 3.5.

As shown, perimeter slot 304 may be defined by a perimeter slot width 308 and a perimeter slot length 310. In some embodiments, perimeter slot width 308 may be any value within a range including 17-19 mm. In some embodiments, the perimeter slot length 310 may be any value within a range including 10-12 mm. A depth of the perimeter slot 304 and e-shaped slots 306a, 306b may equal the thickness of the microstrip patch 206. For example, if the thickness of microstrip patch 206 is 2.3 mm, the perimeter slot 304 and e-shaped slots 306a, 306b may have a depth of 2.3 mm.

As shown, the e-shaped slots 306a, 306b are spaced about a reference axis 320. In some embodiments, an e-slot distance 316a between e-shaped slot 306a and axis 320 may be any value in the range including 17-19 mm. Similarly, the e-slot distance 316b between e-shaped slot 306b and axis 320 may be any value in the range including 25-27 mm. Therefore, a distance (not pictured) between the e-shaped slots 306a, 306b may equal the sum of e-slot distance 316a and e-slot distance 316b. Therefore, in some embodiments, the distance between the e-shaped slots 306a, 306b may be any value in the range of 42-46 mm.

In some embodiments, each slot in the pair of e-shaped slots 306a, 306b have similar or nearly similar dimensions. For example, the e-shaped slots 306a, 306b may be manufactured to have identical (or symmetrical), or nearly identical, dimensions, but due to manufacturing limitations, may not truly be identical. In some embodiments, e-shaped slot 306a and e-shaped slot 306b may have different (e.g., asymmetrical) dimensions.

In the embodiment depicted in FIG. 3B, the dimensions of e-shaped slots 306a, 306b are asymmetrical. For example, e-shaped slot 306a may be defined by an e-slot width 312a and an e-slot length 314a. Similarly, e-shaped slot 306b may be defined by an e-slot width 312b and an e-slot length 314b.

In some embodiments, the e-slot width 312a of e-shaped slot 306a may be any value within a range including 15-17 mm, while the e-slot length 314a of e-shaped slot 306a may be any value within a range including 9-11 mm. In some embodiments, the e-slot width 312b of e-shaped slot 306b may be any value in a range including 13-15 mm, while the e-slot length 314b of e-shaped slot 306b may be any value within a range including 12-14 mm.

As shown, the position of outer conductor 216 and inner conductor 218 of connector 214 are depicted as dashed lines in FIG. 3B. The configuration of the perimeter slot 304 and e-shaped slots 306a, 306b may be based at least in part on the position of the outer conductor 216 and/or inner conductor 218 of connector 214 in the microstrip antenna 302. The axis 320 may be a part of the configuration of the microstrip antenna 302.

An axis 318 may cut through the perimeter slot 304 and intersect with reference axis 320, thereby forming an angle 322. In some embodiments, the angle 322 is any degree within the range of 123-125 degrees. The axis 318 may cut through a midpoint of the perimeter slot width 308 of the perimeter slot 304. Embodiments are not limited in these contexts.

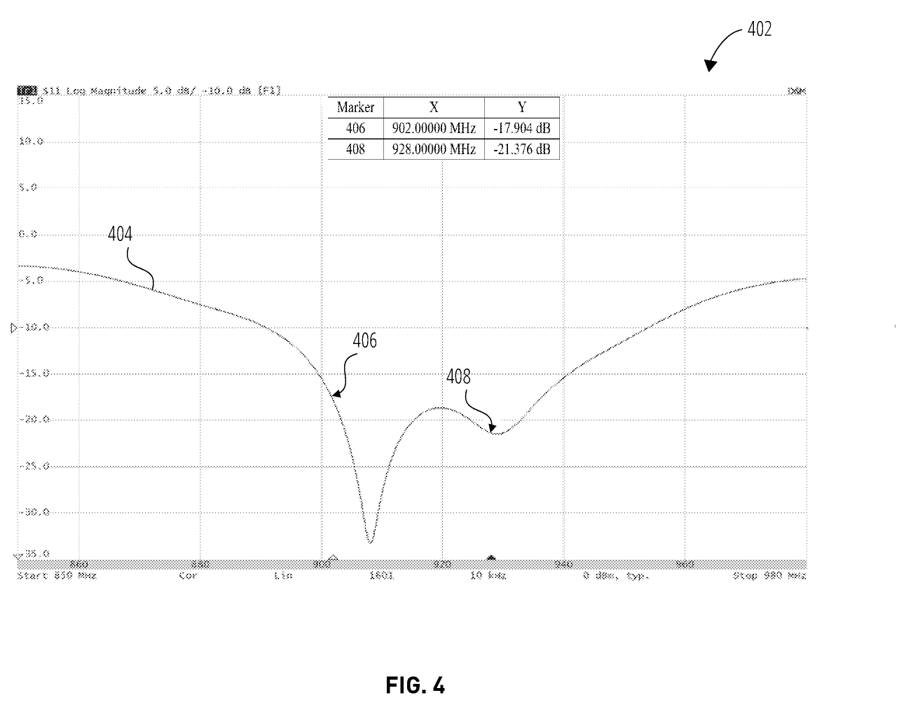

FIG. 4 illustrates a graph 402 of a response curve 404 of the microstrip antenna 302, according to one embodiment. As shown, the x-axis of graph 402 corresponds to signal frequency (in MHz) and the y-axis of graph 402 corresponds to return loss (RL) of the microstrip antenna 302 in decibels (dB). For example, the response curve 404 may be based on tuning the microstrip antenna 302 to meet a predetermined RL requirement between 902-928 MHz as required by the FCC for LoRa wireless communications. As shown, marker 406 and marker 408 depict the return loss of the microstrip antenna 302 at specific frequencies.

The graph 402 depicts the dual-resonance properties of the microstrip antenna 302, e.g., via the “W” shape of the curve 404. The markers 406, 408 in the graph 402 are located proximate to the required LoRa bandwidths at 902 MHz and 928 MHz, respectively. Advantageously, as shown, markers 406, 408 in the graph 402 reflect the dual resonances of the microstrip antenna 302, namely at or near 902 MHz and 928 MHz, respectively. Therefore, microstrip antenna 302 may have dual resonant frequencies at or near 902 MHz and 928 MHz. As shown, the microstrip antenna 302 exhibits a return loss of approximately -17.904 dB at 902 MHz and a return loss of -21.376 dB at 928 MHz.

In contrast, conventional antennas with a single resonance response have a “V” shape response curve when plotting RL over frequency. As such, it is extremely difficult or not possible to make the single resonance “V” have a wide enough shape that could cover a sufficient bandwidth. Advantageously, however, the perimeter slot 304 provides the dual resonant frequency response and the e-shaped slots 306a, 306b shift the response into the desired bandwidth of 902-928 MHz for LoRa communications.

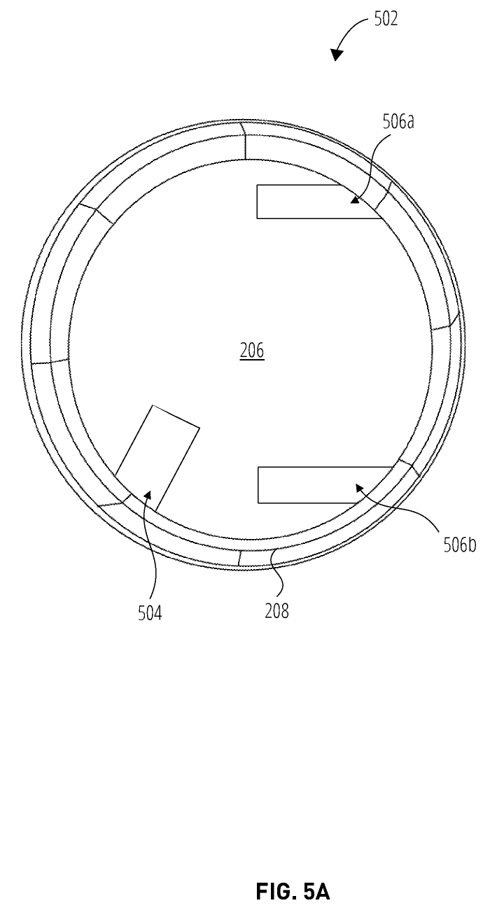

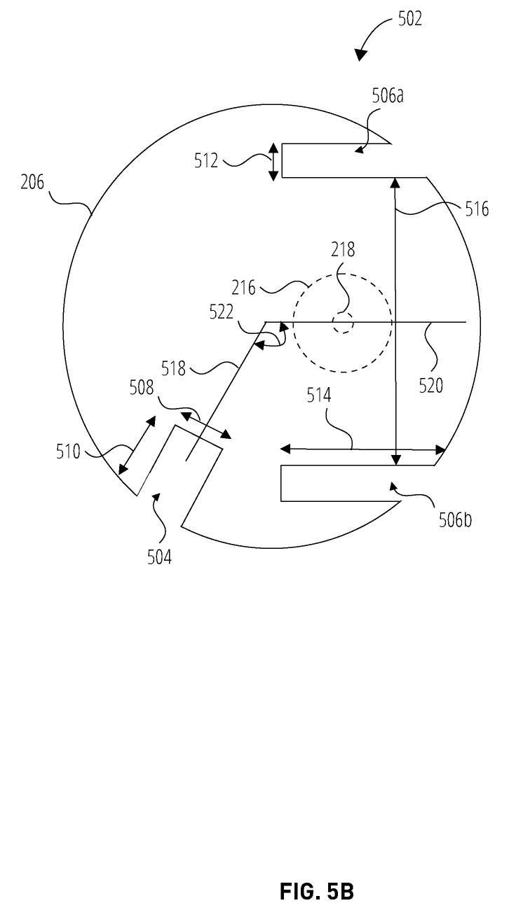

FIG. 5A illustrates an embodiment of a microstrip antenna 502. The microstrip antenna 502 includes components of the microstrip antenna 202, including the microstrip patch 206, substrate 208, ground plane 212, and connector 214 (the ground plane 212 and connector 214 are not pictured due to the two-dimensional limitations of the Figure). Therefore, the microstrip antenna 502 is an example embodiment of the microstrip antenna 202.

As shown, the microstrip antenna 502 of FIG. 5A includes a perimeter slot 504 and a pair of slots (also referred to as an “e-shaped slot”), namely e-shaped slot 506a (e.g., a first slot of the pair of slots) and e-shaped slot 506b (e.g., a second slot of the pair of slots). The e-shaped slot 506a and e-shaped slot 506b may collectively form an e-shaped slot. The perimeter slot 504 and e-shaped slots 506a, 506b are cut into (or otherwise removed from) the microstrip patch 206. Doing so may leave substrate 208 exposed where perimeter slot 504 and e-shaped slots 506a, 506b are cut.

As stated, without modifications, a conventional microstrip antenna exhibits a single resonant response. Stated differently, a conventional microstrip antenna has a single resonant frequency. Furthermore, a conventional microstrip antenna produces a single resonant response at a predetermined frequency. However, a single resonant response may provide limited bandwidth, e.g., at a specific frequency (or subset of frequencies), while other bandwidths may be desired.

For example, the LoRa bandwidth range may be 902-928 MHz. A conventional microstrip antenna may provide a single resonant frequency that is narrowband (e.g., within 910-920 MHz and/or a subset thereof), which is not capable of reaching 10dB return loss for wider bandwidths (e.g., within 902-928 MHz and/or a subset thereof). Similar limitations may be experienced in other wireless communications formats, such as Bluetooth.

Advantageously, however, the microstrip antenna 502 provides a dual resonance response across a desired (e.g., a predetermined) bandwidth. For example, microstrip antenna 502 may provide dual resonance across the 902-928 MHz range for LoRa. More specifically, the perimeter slot 504 may provide a dual resonance response for microstrip antenna 502. However, this response may not be within the desired 902-928 MHz bandwidth. For example, the microstrip antenna 502 with only the perimeter slot 504 may have dual resonances at approximately 1.2 GHz and 1.8 GHz, which is far from the desired bandwidth of 902-928MHz. As another example, providing the perimeter slot 504, without more, may provide a return loss of -4.4dB at 902MHz, far from the -10dB requirement.

Advantageously, however, the pair of e-shaped slots 506a, 506b shift the response to the desired 902-928 MHz range (and/or a subset thereof). For example, the e-shaped slots 506a-506b may shift the dual resonant frequencies lower and closer together relative to only providing the perimeter slot 504. Therefore, the e-shaped slots 506a-506b may have the effect of making the microstrip antenna 502 electrically larger, thereby shifting resonant frequencies lower. As such, the perimeter slot 504 and the pair of e-shaped slots 506a, 506b of the microstrip antenna 502 may cause the microstrip patch 206 to have different resonances. Advantageously, the microstrip antenna 502 may be included in or coupled to any type of apparatus, e.g., a meter interface unit, a metering device, a computing device, a smartphone, etc.

FIG. 5B illustrates a configuration of the microstrip patch 206 of microstrip antenna 502 in greater detail, according to one embodiment. For the sake of clarity, the substrate 208 and ground plane 212 of microstrip antenna 502 are not depicted in FIG. 5B.

In the embodiment depicted in FIG. 5B, a radius of the microstrip patch 206 is 49 mm and the substrate 208 has a thickness of 6 mm. The thickness of the microstrip patch 206 may be of any thickness. For example, the microstrip patch 206 of microstrip antenna 502 may have a thickness of 2.3 mm. In some embodiments, a dielectric constant of the substrate 208 of microstrip antenna 502 is 3.5.

As shown, perimeter slot 504 may be defined by a perimeter slot width 508 and a perimeter slot length 510. In some embodiments, perimeter slot width 508 may be any value within a range including 12-14 mm. In some embodiments, the perimeter slot length 510 may be any value within a range including 18-20 mm. A depth of the perimeter slot 504 and e-shaped slots 506a, 506b may equal the thickness of the microstrip patch 206. For example, if the thickness of microstrip patch 206 is 2.3 mm, the perimeter slot 504 and e-shaped slots 506a, 506b may have a depth of 2.3 mm.

As shown, the e-shaped slots 506a, 506b are separated by an e-slot distance 516. In some embodiments, the e-slot distance 516 may be any value in the range including 65-67 mm. In some embodiments, each slot in the pair of e-shaped slots 506a, 506b have similar or nearly similar dimensions. For example, the e-shaped slots 306a, 306b may be manufactured to have identical (or symmetrical), or nearly identical, dimensions, but due to manufacturing limitations, may not truly be identical. In some embodiments, each slot in the pair of e-shaped slots 506a, 506b may have different (e.g., asymmetrical) dimensions. However, each of e-shaped slots 506a, 506b is defined by an e-slot width 512 and an e-slot length 514. For the sake of clarity, the e-slot width 512 and e-slot length 514 are not pictured for each of e-shaped slots 506a, 506b of FIG. 5A.

The e-slot width 512 of e-shaped slot 506a and e-shaped slot 506b may be any value within a range including 7-9 mm. As stated, in some embodiments, the e-slot width 512 of e-shaped slot 506a and e-shaped slot 506b may be the same and/or different. However, regardless of whether the e-slot width 512 of e-shaped slot 506a and e-shaped slot 506b are the same or different, the values of e-slot width 512 of e-shaped slot 506a and e-shaped slot 506b are within 7-9 mm. For example, in one embodiment, e-shaped slots 506a, 506b may have an e-slot width 512 of 8 mm. As another example, in another embodiment, e-shaped slots 506a, 506b may have e-slot widths 512 of 8.5 mm and 8.3 mm, respectively (e.g., different e-slot widths 512).

The e-slot length 514 of e-shaped slot 506a and e-shaped slot 506b may be any value within a range including 30-33 mm. As stated, in some embodiments, the e-slot length 514 of e-shaped slot 506a and e-shaped slot 506b may be the same and/or different. However, regardless of whether the e-slot length 514 of e-shaped slot 506a and e-shaped slot 506b are the same or different, the values of e-slot length 514 of e-shaped slot 506a and e-shaped slot 506b are within 30-33 mm. For example, in one embodiment, e-shaped slots 506a, 506b may have an e-slot length 514 of 33 mm. As another example, in another embodiment, e-shaped slots 506a, 506b may have e-slot lengths 514 of 32.5 mm and 32.3 mm, respectively (e.g., different e-slot lengths 514).

As shown, the position of outer conductor 216 and inner conductor 218 of connector 214 are depicted as dashed lines in FIG. 5B. The configuration of the perimeter slot 504 and e-shaped slots 506a, 506b may be based at least in part on the position of the outer conductor 216 and/or inner conductor 218 of connector 214 in the microstrip antenna 502. A reference axis 520 may be a part of the configuration of the microstrip antenna 502. The reference axis 520 cuts through (e.g., bisects) the midpoint of the e-slot distance 516 and the inner conductor 218. Therefore, in some embodiments, e-shaped slot 506a and e-shaped slot 506b are symmetrical about the axis 520. An axis 518 may cut through the perimeter slot 504 and intersect with reference axis 520, thereby forming an angle 522. In some embodiments, the angle 522 is any value within the range of 116-118 degrees. The axis 518 may cut through a midpoint of the width of the perimeter slot 504.

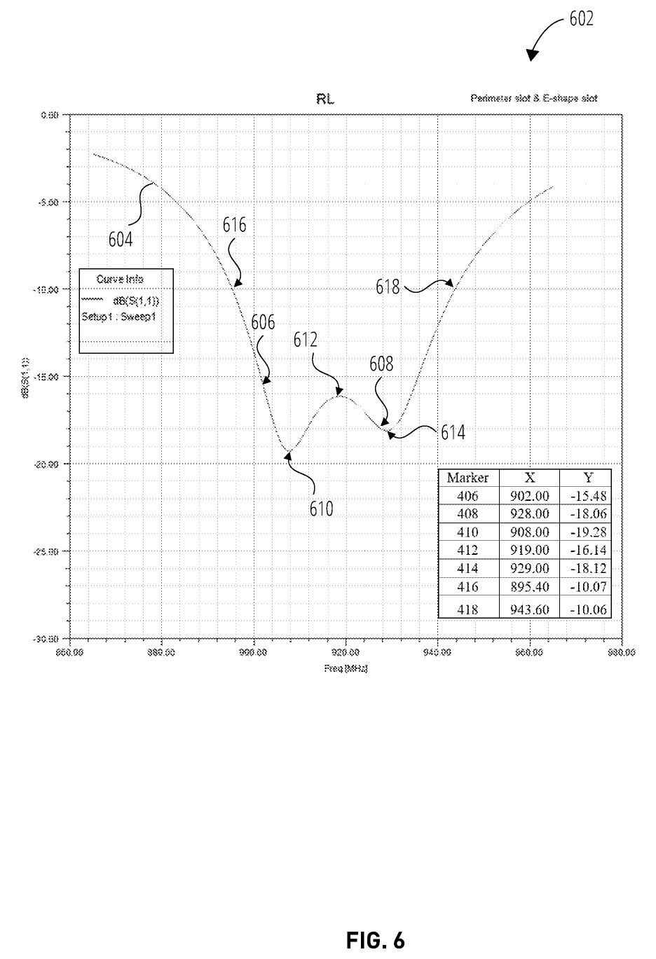

FIG. 6 illustrates a graph 602 of a response curve 604 of the microstrip antenna 502, according to one embodiment. As shown, the x-axis of graph 602 corresponds to signal frequency (in MHz) and the y-axis of graph 602 corresponds to return loss of the microstrip antenna 502 in decibels. For example, the response curve 604 may be based on tuning the microstrip antenna 502 to meet a 10dB RL requirement between 902-928 MHz as required by the FCC for LoRa wireless communications. Various markers 606-618 depict the return loss of the microstrip antenna 502 at specific frequencies.

The graph 602 depicts the dual-resonance properties of the microstrip antenna 502, e.g., via the “W” shape of the curve 604. The markers 616, 618 in the graph 602 are located proximate to the required LoRa bandwidths at 902 MHz and 928 MHz, respectively. Advantageously, as shown, markers 610, 614 in the graph 602 reflect the dual resonances of the microstrip antenna 502, namely at or near 919 MHz and 929 MHz, respectively. Therefore, microstrip antenna 502 may have dual resonant frequencies at or near 919 MHz and 929 MHz. Moreover, the microstrip antenna 502 advantageously exhibits a return loss of less than -15 dB for all frequencies in the desired bandwidth of 902-928 MHz.

In contrast, conventional antennas with a single resonance response have a “V” shape response curve when plotting RL over frequency. As such, it is extremely difficult or not possible to make the single resonance “V” have a wide enough shape that could cover a sufficient bandwidth. Advantageously, however, the perimeter slot 504 provides the dual resonant frequency response and the e-shaped slots 506a, 506b shift the response into the desired bandwidth of 902-928 MHz for LoRa communications.

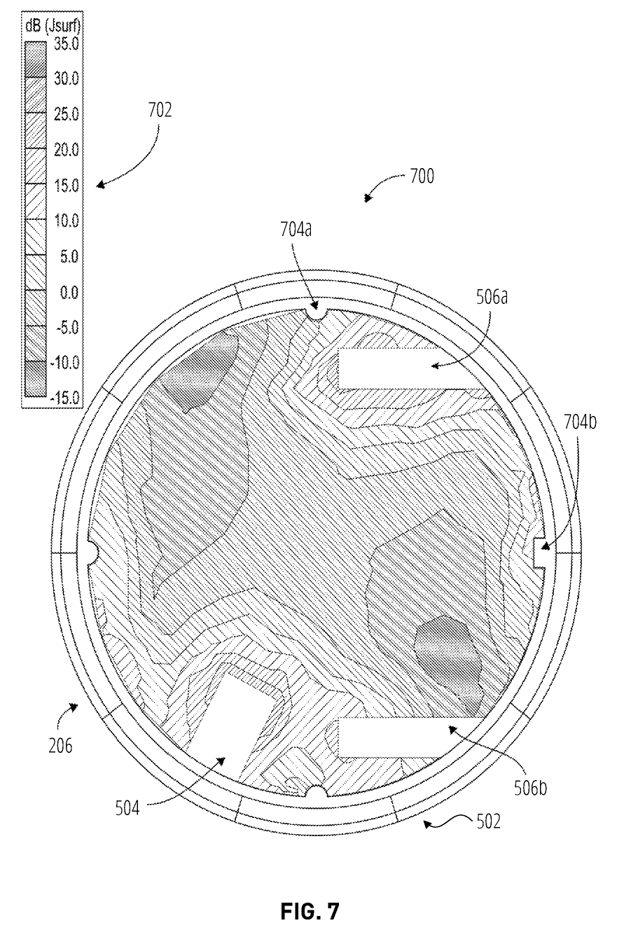

FIG. 7 illustrates a surface current density plot 700 of the microstrip patch 206 of the microstrip antenna 502 of FIG. 5A, according to one embodiment. The surface current density plot 700 generally reflects the surface current density on the microstrip patch 206 at

marker 616 of the graph 602 (e.g., 895.4 MHz). The surface current density plot 700 is overlaid on the microstrip patch 206 (which includes the perimeter slot 504 and e-shaped slots 506a, 506b), to reflect the current density at different locations of the microstrip patch 206 at 895.4 MHz. In some embodiments, the microstrip patch 206 of microstrip antenna 302 exhibits the same and/or similar surface current densities as those depicted in surface current density plot 700.

The surface current density legend 702 is a legend of the current density of the surface current density plot 700, where lower dB values indicate lower current density. Advantageously, via the perimeter slot 504 and pair of e-shaped slots 506a, 506b, the high current density areas of the microstrip antenna 502 signify active areas of the antenna at 895.4 MHz.

The microstrip patches 206 depicted in FIG. 7-FIG. 13 include small cut out areas (notches) including 704a and 704b. In some embodiments, portions of the substrate 208 may extend into these notches. These are mechanical features to ensure one-way assembly to prevent manufacturing errors. These notches have little or no effect on the electrical performance of the antenna. Therefore, the microstrip antenna 302, microstrip antenna 502 and/or microstrip antenna 1402 may include such notches.

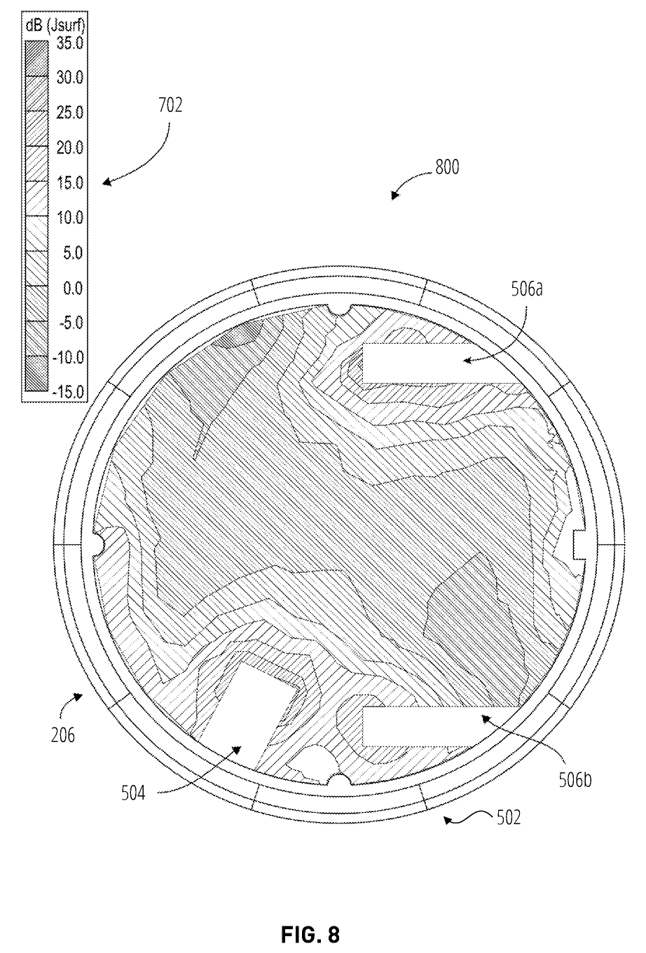

FIG. 8 illustrates a surface current density plot 800 of the microstrip patch 206 of the microstrip antenna 502 of FIG. 5A, according to one embodiment. The surface current density plot 800 generally reflects the surface current density on the microstrip patch 206 at marker 606 of the graph 602 (e.g., 902 MHz). The surface current density plot 800 is overlaid on the microstrip patch 206 (which includes the perimeter slot 504 and e-shaped slots 506a, 506b), to reflect the current density at different locations of the microstrip patch 206 at 902 MHz. In some embodiments, the microstrip patch 206 of microstrip antenna 302 exhibits the same and/or similar surface current densities as those depicted in surface current density plot 800.

Advantageously, via the perimeter slot 504 and pair of e-shaped slots 506a, 506b, the high current density areas of the microstrip antenna 502 signify active areas of the antenna at 902 MHz.

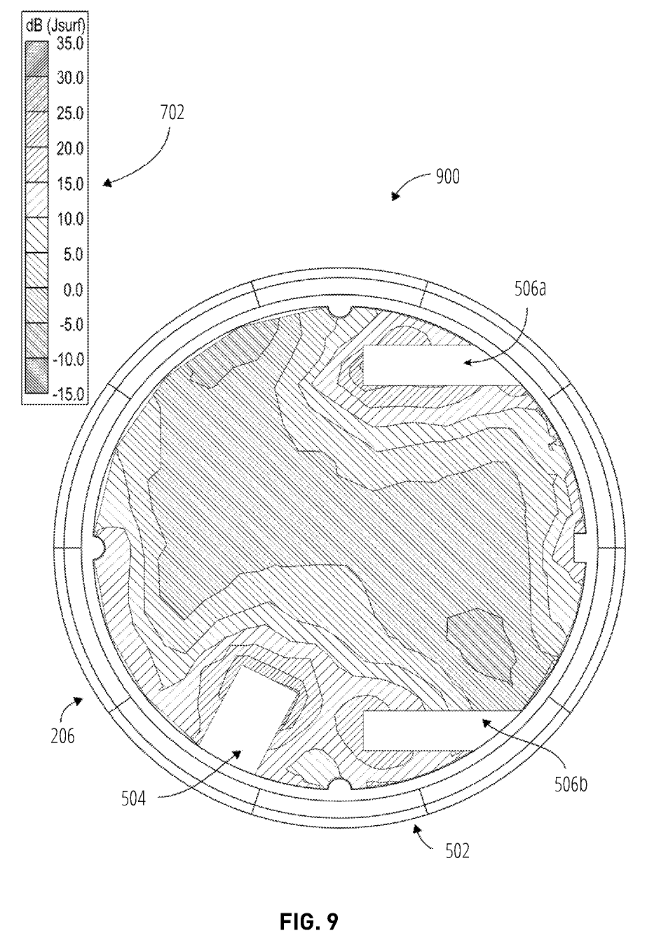

FIG. 9 illustrates a surface current density plot 900 of the microstrip patch 206 of the microstrip antenna 502 of FIG. 5A, according to one embodiment. The surface current density plot 900 generally reflects the surface current density on the microstrip patch 206 at marker 610 of the graph 602 (e.g., 908 MHz). The surface current density plot 900 is overlaid on the microstrip patch 206 (which includes the perimeter slot 504 and e-shaped slots 506a, 506b), to reflect the current density at different locations of the microstrip patch 206 at 908 MHz. In some embodiments, the microstrip patch 206 of microstrip antenna 302 exhibits the same and/or similar surface current densities as those depicted in surface current density plot 900.

Advantageously, via the perimeter slot 504 and pair of e-shaped slots 506a, 506b, the high current density areas of the microstrip antenna 502 signify active areas of the antenna at 908 MHz.

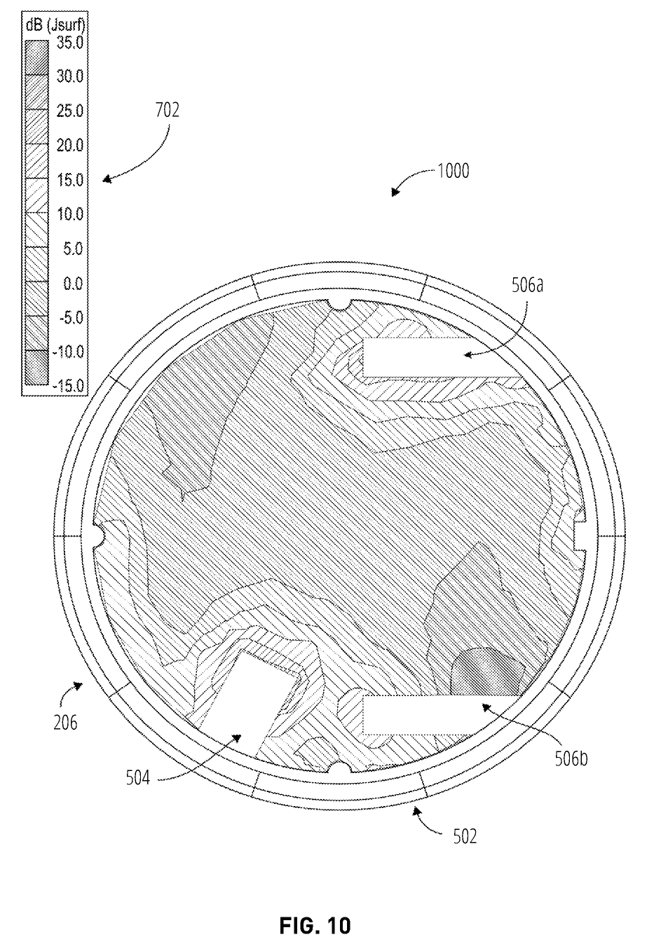

FIG. 10 illustrates a surface current density plot 1000 of the microstrip patch 206 of the microstrip antenna 502 of FIG. 5A, according to one embodiment. The surface current density plot 1000 generally reflects the surface current density on the microstrip patch 206 at marker 612 of the graph 602 (e.g., 919 MHz). The surface current density plot 1000 is overlaid on the microstrip patch 206 (which includes the perimeter slot 504 and e-shaped slots 506a, 506b), to reflect the current density at different locations of the microstrip patch 206 at 919 MHz. In some embodiments, the microstrip patch 206 of microstrip antenna 302 exhibits the same and/or similar surface current densities as those depicted in surface current density plot 1000.

Advantageously, via the perimeter slot 504 and pair of e-shaped slots 506a, 506b, the high current density areas of the microstrip antenna 502 signify active areas of the antenna at 919 MHz.

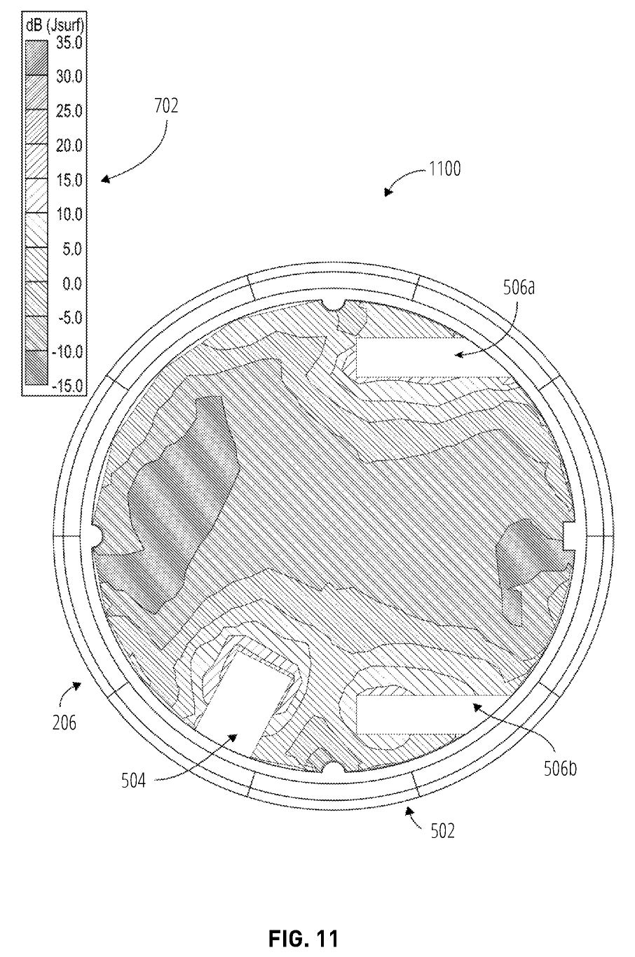

FIG. 11 illustrates a surface current density plot 1100 of the microstrip patch 206 of the microstrip antenna 502 of FIG. 5A, according to one embodiment. The surface current density plot 1100 generally reflects the surface current density on the microstrip patch 206 at marker 608 of the graph 602 (e.g., 928 MHz). The surface current density plot 1100 is overlaid on the microstrip patch 206 (which includes the perimeter slot 504 and e-shaped slots 506a, 506b), to reflect the current density at different locations of the microstrip patch 206 at 928 MHz. In some embodiments, the microstrip patch 206 of microstrip antenna 302 exhibits the same and/or similar surface current densities as those depicted in surface current density plot 1100.

Advantageously, via the perimeter slot 504 and pair of e-shaped slots 506a, 506b, the high current density areas of the microstrip antenna 502 signify active areas of the antenna at 928 MHz.

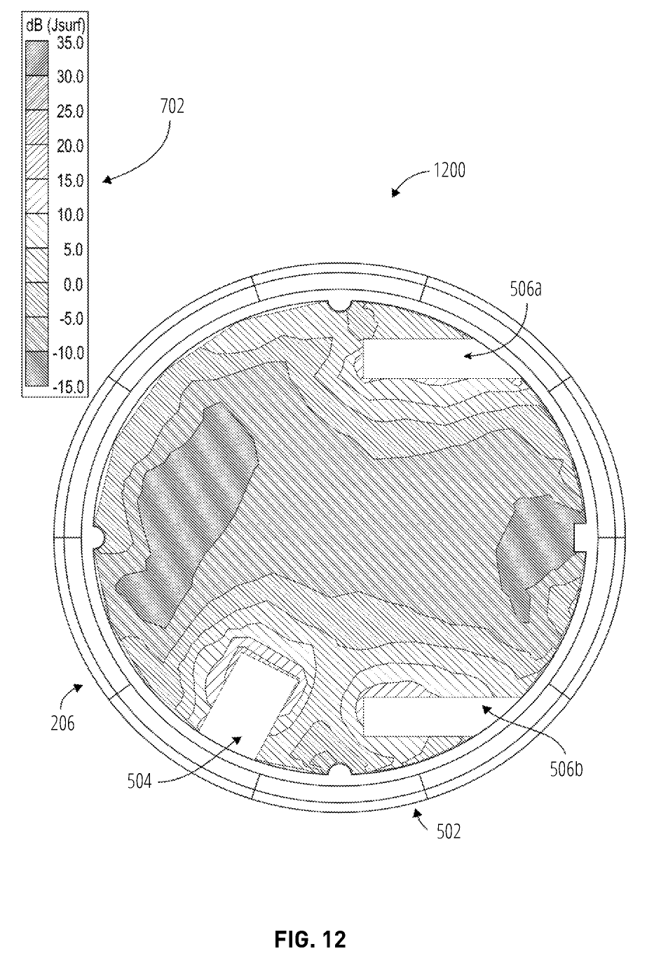

FIG. 12 illustrates a surface current density plot 1200 of the microstrip patch 206 of the microstrip antenna 502 of FIG. 5A, according to one embodiment. The surface current density plot 1200 generally reflects the surface current density on the microstrip patch 206 at marker 614 of the graph 602 (e.g., 929 MHz). The surface current density plot 1200 is overlaid on the microstrip patch 206 (which includes the perimeter slot 504 and e-shaped slots 506a, 506b), to reflect the current density at different locations of the microstrip patch 206 at 929 MHz. In some embodiments, the microstrip patch 206 of microstrip antenna 302 exhibits the same and/or similar surface current densities as those depicted in surface current density plot 1200.

Advantageously, via the perimeter slot 504 and pair of e-shaped slots 506a, 506b, the high current density areas of the microstrip antenna 502 signify active areas of the antenna at 929 MHz.

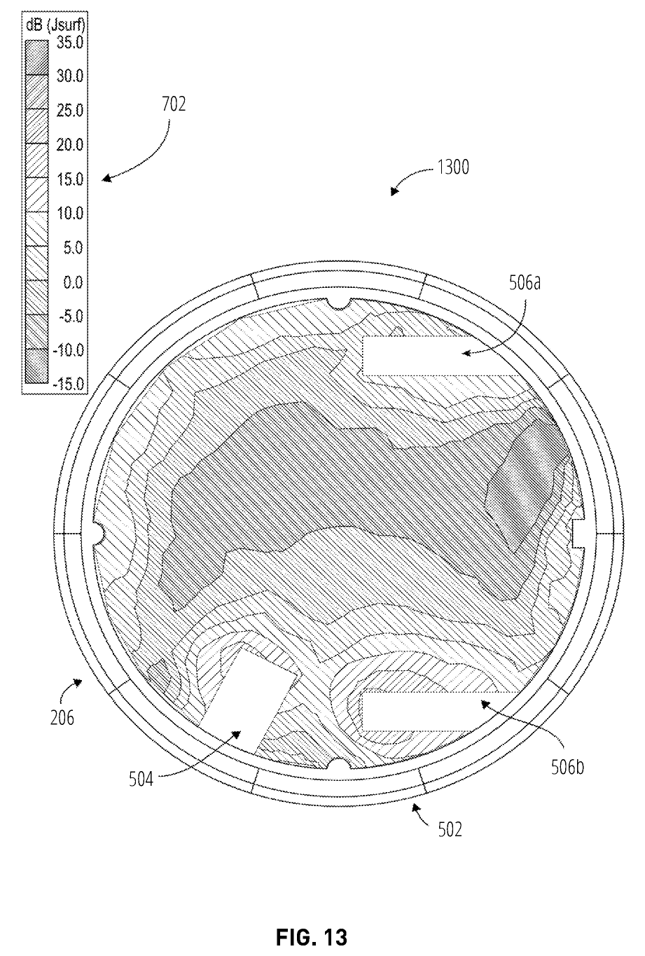

FIG. 13 illustrates a surface current density plot 1300 of the microstrip patch 206 of the microstrip antenna 502 of FIG. 5A, according to one embodiment. The surface current density plot 1300 generally reflects the surface current density on the microstrip patch 206 at marker 618 of the graph 602 (e.g., 943.6 MHz). The surface current density plot 1300 is overlaid on the microstrip patch 206 (which includes the perimeter slot 504 and e-shaped slots 506a, 506b), to reflect the current density at different locations of the microstrip patch 206 at 943.6 MHz. In some embodiments, the microstrip patch 206 of microstrip antenna 302 exhibits the same and/or similar surface current densities as those depicted in surface current density plot 1300.

Advantageously, the high current density areas of the microstrip antenna 502 signify active areas of the antenna at 943.6 MHz. Furthermore, as illustrated by surface current density plots 700-1300, the microstrip antenna 502 achieves high current density across a wide range of frequencies.

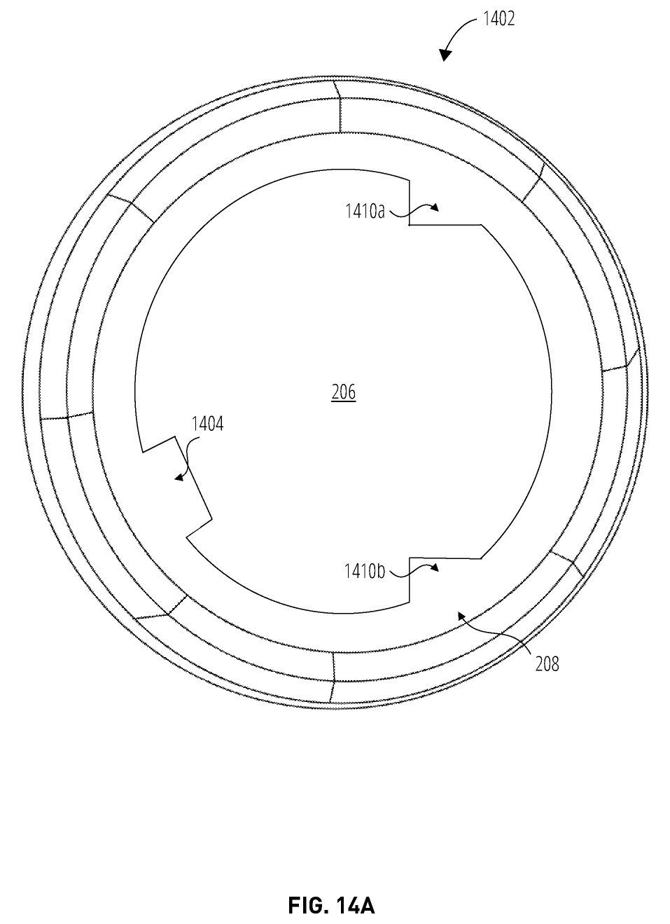

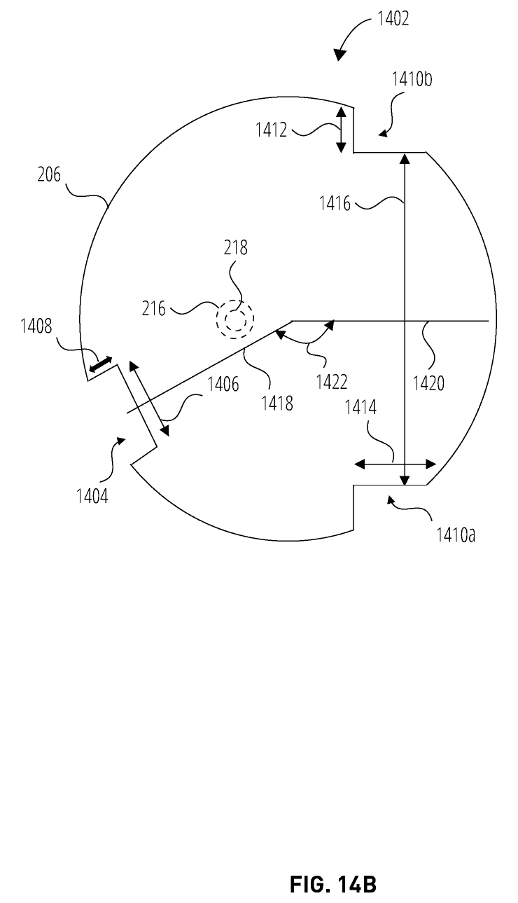

FIG. 14A illustrates an example of a microstrip antenna 1402, according to one embodiment. The microstrip antenna 1402 may include components of the microstrip antenna 202, including the microstrip patch 206, substrate 208, ground plane 212, and connector 214 (the ground plane 212 and connector 214 are not pictured due to the two-dimensional limitations of the Figure). Therefore, the microstrip antenna 1402 is an example embodiment of the microstrip antenna 202.

As shown, microstrip antenna 1402 includes a perimeter slot 1404 and a pair of slots, the pair of slots including an e-shaped slot 1410a and an e-shaped slot 1410b. The perimeter slot 1404 and e-shaped slots 1410a, 1410b are cut into the microstrip patch 206. Doing so may leave substrate 208 exposed where perimeter slot 1404 and e-shaped slots 1410a, 1410b are cut.

The microstrip antenna 1402 advantageously provides a dual resonance response across a desired bandwidth. For example, microstrip antenna 1402 may provide dual resonance for Bluetooth communications. In some embodiments, the microstrip antenna 1402 may provide dual resonance at bandwidths of 2.402-2.480 GHz and/or 2.400-2.4835 GHz. More specifically, the perimeter slot 1404 may provide the dual resonance response. However, this response may not be at the desired 2.4 GHz bandwidth. Advantageously, however, the pair of e-shaped slots 1410a, 1410b shift the response to the desired 2.4 GHz bandwidth. For example, the e-shaped slots 1410a, 1410b may shift the dual resonant frequencies lower and closer together relative to only providing the perimeter slot 1404. Therefore, the e-shaped slots 1410a, 1410b may have the effect of making the microstrip antenna 1402 electrically larger, thereby shifting resonant frequencies lower. As such, the perimeter slot 1404 and the pair of e-shaped slots 1410a, 1410b of the microstrip antenna 1402 may cause different portions of the microstrip patch 206 to have different resonances.

Advantageously, the microstrip antenna 1402 may be included in or coupled to any type of apparatus, e.g., a meter interface unit, a metering device, a computing device, a smartphone, etc.

FIG. 14B illustrates a configuration of the microstrip patch 206 of microstrip antenna 1402 in greater detail, according to one embodiment. For the sake of clarity, the substrate 208 and ground plane 212 of microstrip antenna 1402 are not depicted in FIG. 14B.

In the embodiment depicted in FIG. 14B, a radius of the microstrip patch 206 is 18 mm and the substrate 208 has a thickness of 2mm. The thickness of the microstrip patch 206 of the microstrip antenna 1402 may be of any thickness. For example, the microstrip patch 206 may have a thickness of 2.3 mm. In some embodiments, a dielectric constant of the substrate 208 of microstrip antenna 1402 is 3.5.

As shown, perimeter slot 1404 may be defined by a perimeter slot width 1406 and a perimeter slot length 1408. In some embodiments, perimeter slot width 1406 may be of any value within a range including 6-8 mm. In some embodiments, the perimeter slot length 1408 may be any value within a range including 2-4 mm. A depth of the perimeter slot 1404 and e-shaped slots 1410a, 1410b may equal the thickness of the microstrip patch 206. For example, if the thickness of microstrip patch 206 is 2.3 mm, the perimeter slot 1404 and e-shaped slots 1410a, 1410b may have a depth of 2.3 mm.

As shown, the e-shaped slots 1410a, 1410b are separated by an e-slot distance 1416. In some embodiments, the e-slot distance 1416 may be any value in the range including 27-29 mm. In some embodiments, each slot in the pair of e-shaped slots 1410a, 1410b have identical dimensions. In some embodiments, each slot in the pair of e-shaped slots 1410a, 1410b may have different dimensions. However, each of e-shaped slots 1410a, 1410b is defined by a respective e-slot width 1412 and a respective e-slot length 1414. For the sake of clarity, the e-slot width 1412 and e-slot length 1414 are not pictured for each of e-shaped slots 1410a, 1410b of FIG. 14B.

The e-slot width 1412 of e-shaped slot 1410a and e-shaped slot 1410b may be any value within a range including 2-4 mm. As stated, in some embodiments, the e-slot width 1412 of e-shaped slot 1410a and e-shaped slot 1410b may be the same and/or different. However, regardless of whether the e-slot width 1412 of e-shaped slot 1410a and e-shaped slot 1410b are the same or different, the values of e-slot width 1412 of e-shaped slot 1410a and e-shaped slot 1410b are within 2-4 mm. For example, in one embodiment, e-shaped slots 1410a, 1410b may have an e-slot width 1412 of 3 mm. As another example, in another embodiment, e-shaped slots 1410a, 1410b may have e-slot widths 1412 of 3.5 mm and 3.3 mm, respectively (e.g., different e-slot widths 1412).

The e-slot length 1414 of e-shaped slots 1410a, 1410b may be any value within a range including 4-6 mm. As stated, in some embodiments, the e-slot length 1414 of e-shaped slot 1410a and e-shaped slot 1410b may be the same and/or different. However, regardless of whether the e-slot length 1414 of e-shaped slots 1410a and e-shaped slot 1410b are the same or different, the values of e-slot length 1414 of e-shaped slot 1410a and e-shaped slot 1410b are within 4-6 mm. For example, in one embodiment, e-shaped slots 1410a, 1410b may have an e-slot length 1414 of 5 mm. As another example, in another embodiment, e-shaped slots 1410a, 1410b may have e-slot lengths 1414 of 4.5 mm and 5.5 mm, respectively (e.g., different e-slot lengths 1414).

As shown, the location of outer conductor 216 and inner conductor 218 are depicted as dashed lines in FIG. 14B. The configuration of the perimeter slot 1404 and e-shaped slots 1410a, 1410b may be based at least in part on the position of the outer conductor 216 and/or inner conductor 218 of connector 214 in the microstrip antenna 1402. A reference axis 1420 may be defined as a parameter of the microstrip antenna 1402. The reference axis 1420 cuts through the midpoint of the e-slot distance 1416. Therefore, in some embodiments, e-shaped slot 1410a and e-shaped slot 1410b are symmetrical about the axis 1420.

In the embodiment of FIG. 14B, the outer conductor 216 and inner conductor 218 are offset from the reference axis 518. However, as shown, the outer conductor 216 and/or inner conductor 218 may be aligned with reference axis 1420 (e.g., if extended, reference axis 1420 would intersect with the midpoint of outer conductor 216 and/or inner conductor 218). An axis 1418 may cut through the perimeter slot 1404 and intersect with reference axis 1420, thereby forming an angle 1422. In some embodiments, the angle 1422 is any value within the range of 149-151 degrees. The axis 1418 may cut through a midpoint of the width of the perimeter slot 1404.

Although specific communication types and/or bandwidths are disclosed as reference examples herein, the disclosure is equally applicable to other types of communications and/or bandwidths. For example, a microstrip antenna as disclosed herein may have a perimeter slot and a pair of slots (e.g., an e-slot) configured to provide improved dual resonance at any desired bandwidth. The configuration may be based on one or more of: (i) a radius of the microstrip patch, (ii) a location of a feed point (or connector) of the microstrip antenna, (iii) a thickness of the substrate, (iv) one or more dimensions (e.g., length and width) of the perimeter slot, (v) one or more dimensions (e.g., length and width) of the pair of slots, (vi) an angle of orientation of the perimeter slot relative to the pair of slots, (vii) a distance between the slots in the pair of slots, or any combination thereof. Doing so may be advantageous as new regulations change the bandwidth requirements for a given wireless communications type.

For example, the microstrip antenna may be tuned to provide dual resonance for cellular antennas, Bluetooth Low Energy (BLE) antennas, etc. As another example, a cellular microstrip antenna may have a configuration of a perimeter slot and a pair of slots (e.g., an e-slot) to cause the antenna to exhibit dual resonance within the 5G cellular frequencies of 410 MHz – 7.125 GHz, 24.25 GHz – 52.6 GHz, or any subset thereof. As another example, a cellular microstrip antenna may have a configuration of a perimeter slot and a pair of slots (e.g., an e-slot) to cause the antenna to exhibit dual resonance at the 4G cellular frequencies of 698-960 MHz, 1700-2400 MHz, or any subset thereof. For example, the 4G cellular frequencies may be associated with Long-Term Evolution (LTE) cellular networks. Embodiments are not limited in these contexts.

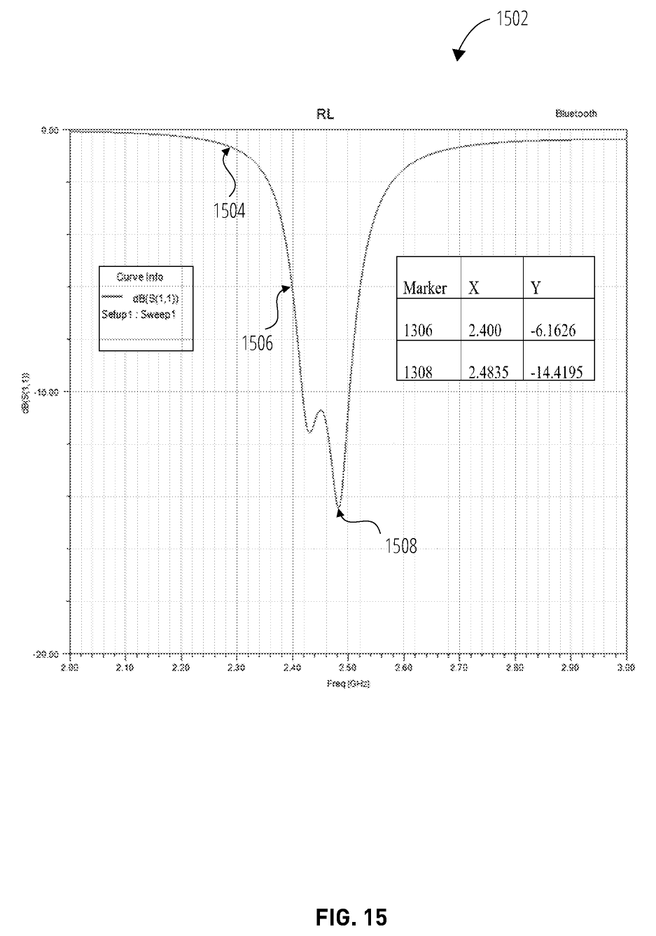

FIG. 15 illustrates a graph 1502 of a response curve 1504 of the microstrip antenna 1402, according to one embodiment. As shown, the x-axis of graph 1502 corresponds to signal frequency (in GHz) and the y-axis of graph 1502 corresponds to return loss (RL) of the microstrip antenna 1402 in decibels (dB). For example, the response graph 1502 may be based on tuning the microstrip antenna 1402 to meet a 10dB RL requirement between 2.400-2.4835 GHz as required by the FCC for Bluetooth wireless communications.

The graph 1502 depicts the dual-resonance properties of the microstrip antenna 1402, e.g., via the “W” shape of the curve 1504. The markers 1506, 1508 in the graph 1502 are located at or near the required Bluetooth bandwidths at 2.400 and 2.4835 GHz, respectively. Advantageously, the graph 1502 reflects the dual resonances of the microstrip antenna 1402, namely at 2.429 GHz and 2.4385 GHz, respectively. Therefore, microstrip antenna 1402 may have dual resonant frequencies at 2.429 GHz and 2.4385 GHz. Moreover, the microstrip antenna 1402 advantageously exhibits a dual-resonance response in the desired bandwidth of 2.4-2.4835 GHz.

In contrast, conventional antennas with a single resonance response have a “V” shape response curve when plotting RL over frequency. As such, it is extremely difficult or not possible to make the single resonance “V” have a wide enough shape that could cover a sufficient bandwidth. Advantageously, however, the perimeter slot 1404 provides the dual resonant frequency response and the e-shaped slots 1410a, 1410b shift the response into the desired bandwidth of 2.400-2.4835 GHz for Bluetooth communications.

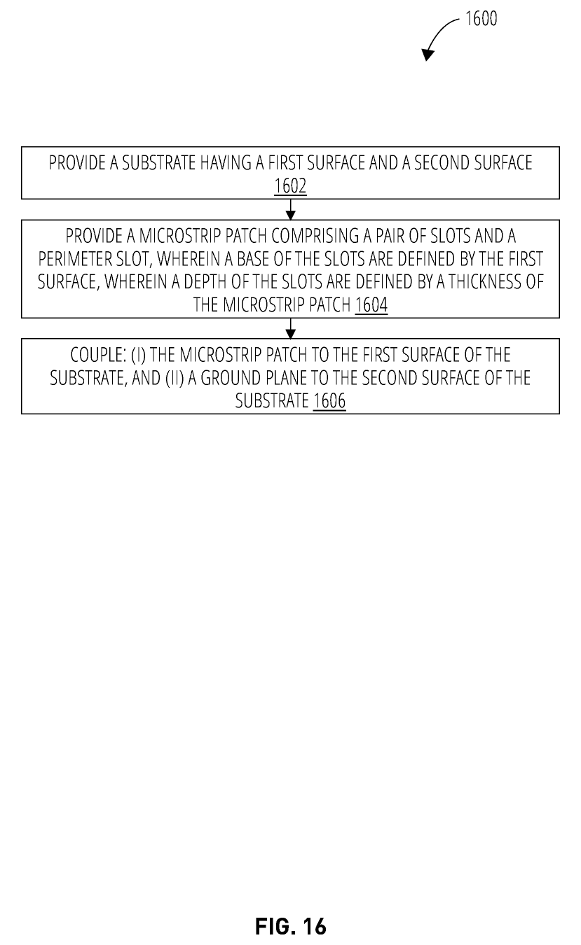

FIG. 16 illustrates an example method 1600 for manufacturing a microstrip antenna, according to one embodiment. Although the example method 1600 depicts a particular sequence of operations, the sequence may be altered without departing from the scope of the present disclosure. For example, some of the operations depicted may be performed in parallel or in a different sequence that does not materially affect the function of the method 1600. In other examples, different components of an example device or system that implements the method 1600 may perform functions at substantially the same time or in a specific sequence.

According to some examples, the method 1600 includes providing a substrate having a first surface and a second surface at block 1602. For example, the substrate may be substrate 208.

According to some examples, the method 1600 includes providing a microstrip patch comprising a pair of slots and a perimeter slot, wherein a base of the slots are defined by the first surface, wherein a depth of the slots are defined by a thickness of the microstrip patch at block 1604. For example, the microstrip patch 206 may include the perimeter slot 304 and e-shaped slots 306a, 306b of microstrip antenna 302. As another example, the microstrip patch 206 may include the perimeter slot 504 and e-shaped slots 506a, 506b of microstrip antenna 502. As another example, the microstrip patch 206 may include perimeter slot 1404 and e-shaped slots 1410a, 1410b of microstrip antenna 1402. Embodiments are not limited in these contexts.

According to some examples, the method 1600 includes coupling: (i) the microstrip patch to the first surface of the substrate, and (ii) a ground plane to the second surface of the substrate at block 1606. Embodiments are not limited in these contexts.

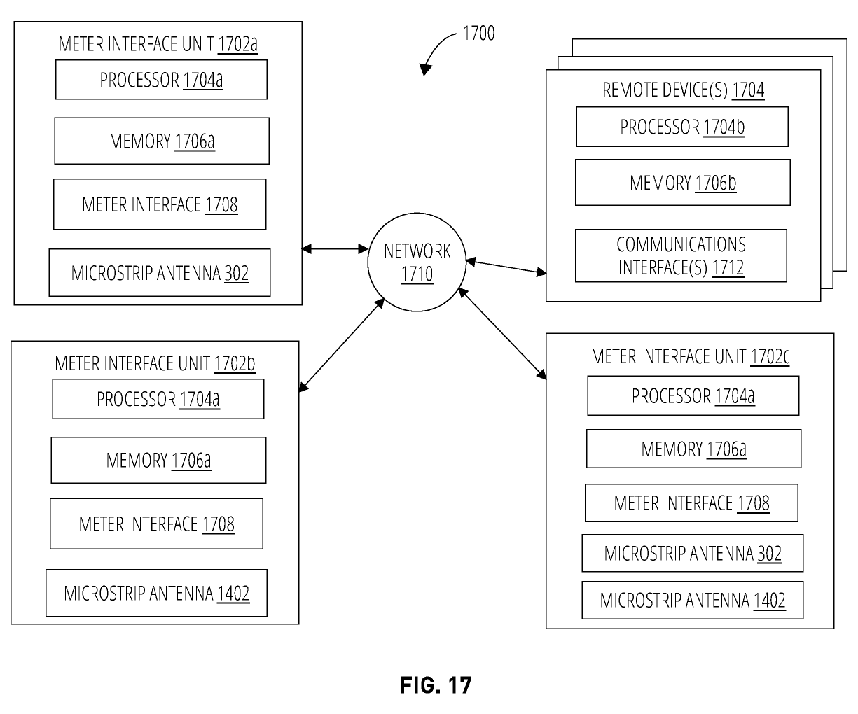

FIG. 17 illustrates a system 1700, according to one embodiment. As shown, the system 1700 includes a plurality of meter interface units 1702a-1702c and one or more remote devices 1704 coupled via one or more wireless communications networks 1710. As shown, each of the meter interface units 1702a-1702c include a processor 1704a, a memory 1706a, and a meter interface 1708. The meter interface units 1702a-1702c may be coupled to a metering device, such as a water meter, gas meter, or electricity meter. However, in some embodiments, the meter interface units 1702a-1702c (and/or components thereof) are components of the metering device itself.

Although three different meter interface units 1702a-1702c are depicted in FIG. 17, any number of meter interface units 1702a-1702c may be present in the system 1700, e.g., tens, hundreds, thousands, or more. Furthermore, as shown, the meter interface units 1702a-1702c may include or otherwise be coupled to one or more microstrip antennas. For example, as shown, meter interface unit 1702a includes microstrip antenna 302, while meter interface unit 1702b includes microstrip antenna 1402, and meter interface unit 1702c includes microstrip antenna 302 and microstrip antenna 1402. In some embodiments, the meter interface units 1702a-1702c may include one or more of the microstrip antenna 302, microstrip antenna 502, and/or microstrip antenna 1402. In some embodiments, the meter interface units 1702a-1702c may include one or more microstrip antennas, e.g., microstrip antenna 202, with one or more perimeter slots and two or more e-shaped slots.

The meter interface units 1702a-1702c may include additional circuitry to allow the processor 1704a to transmit and/or receive data via the microstrip antenna 302, microstrip antenna 502, and/or microstrip antenna 1402, e.g., a transceiver, a radio frequency (RF) frontend (e.g., amplifiers, filters, switches, and/or mixers), an analog-to-digital converter (ADC), a digital signal processor (DSP), clock and timing circuits, impedance matching circuits, phase-locked loop (PLL), noise cancellation circuits, and/or a baseband processor.

As shown, the remote devices 1704 include a processor 1704b, a memory 1706b, and one or more communications interfaces 1712. The communications interface 1712 may be any number and type of wireless communications interfaces. For example, the communications interface 1712 may be a LoRa interface. As another example, the communications interface 1712 may be a Bluetooth interface. In some embodiments, the remote devices 1704 include a LoRa communications interface 1712 and a Bluetooth communications interface 1712. In some embodiments, the remote device 1704 includes interfaces for LoRa, Bluetooth, Wi-Fi, and cellular. In some embodiments, the communications interface 1712 includes or is otherwise coupled to microstrip antenna 302, microstrip antenna 502, and/or microstrip antenna 1402.

Examples of the remote devices 1704 therefore include smartphones, hand-held devices that communicate with the meter interface units 1702a-1702c, other meter interface units 1702a-1702c, wireless gateway devices, networking devices, servers, or any other computing device. The connections established via the network 1710 include direct wireless communications (e.g., the microstrip antenna 302 and/or microstrip antenna 502 may be used to establish direct wireless communications with a remote device 1704 configured as a LoRa wireless gateway). As another example, the microstrip antenna 1402 may be used to establish direct Bluetooth communications with a remote device 1704 such as a smartphone or other handheld device.

For example, the utility meters and the meter interface units 1702a-1702c may be a part of an automated meter reading (AMR) system, an advanced metering system (AMS), an advanced meter infrastructure (AMI), or any other type of architecture associated with a utility company or another entity. Therefore, the meter interface units 1702a-1702c may receive meter readings from the meter via the meter interface 1708 and transmit the readings to a device such as a backend server (e.g., one or more remote devices 1704). The meter interface 1708 may be any type of wired and/or wireless interface to a metering device and/or component thereof (e.g., registers, etc.).

More generally, using the microstrip antenna 302, microstrip antenna 502, and/or microstrip antenna 1402, the meter interface units 1702a-1702c may communicate with the remote devices 1704. For example, the processor 1704a of meter interface unit 1702a may receive data from the meter (e.g., a meter reading, a meter configuration, etc.) via the meter interface 1708, and cause the microstrip antenna 302 to transmit indications of the data to a remote device 1704. In some embodiments, the data is communicated based on a request received from the remote device 1704 via the microstrip antenna 302.

As another example, the remote device 1704 may transmit signal for a command, request, or other instruction to the microstrip antenna 1402 of meter interface unit 1702b via the communications interface 1712. The signal received by the microstrip antenna 1402 (and/or an indication thereof) may be provided to the processor 1704a of meter interface unit 1702a. Processor 1704a may then cause a corresponding operation to be performed (e.g., return data from the meter interface unit 1702a to the remote device 1704, receive and return data from the meter to the remote device 1704, modify a configuration of the meter, modify a configuration of the meter interface unit 1702b, etc.).

As yet another example, meter interface unit 1702c may receive a command from remote device 1704 via microstrip antenna 302 and/or microstrip antenna 1402. The signal received by the microstrip antenna 302 and/or microstrip antenna 1402 (and/or an indication thereof) may be provided to the processor 1704a of meter interface unit 1702a. Processor 1704a may then cause a corresponding operation to be performed (e.g., return data from the meter interface unit 1702c to the remote device 1704, receive and return data from the meter to the remote device 1704, modify a configuration of the meter, modify a configuration of the meter interface unit 1702c, etc.). As another example, meter interface unit 1702c may receive a Bluetooth request from a smartphone remote device 1704 via microstrip antenna 1402. The meter interface unit 1702c may respond to the request by sending a Bluetooth response to remote device 1704 via microstrip antenna 1402. The meter interface unit 1702c may also respond or otherwise communicate with other remote devices 1704 via the microstrip antenna 302. Embodiments are not limited in these contexts, as any number and type of operations may be supported by the system 1700.

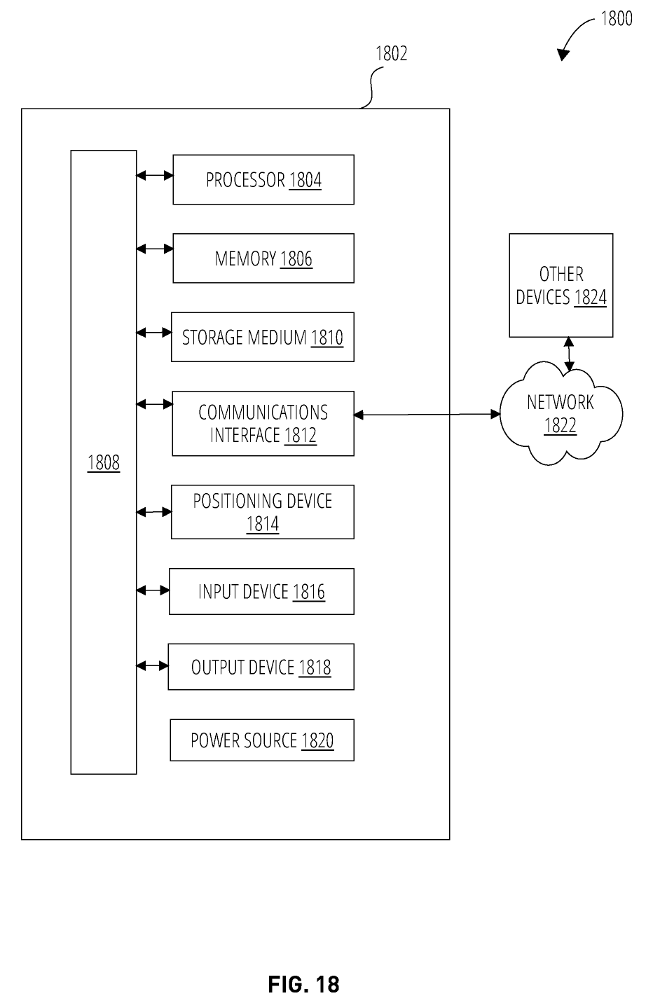

FIG. 18 illustrates an example computing system 1800 suitable for implementing various embodiments as described herein. As shown, the computing system 1800 includes a device 1802, represents any type of physical and/or virtualized device. Examples of the device 1802 include, but are not limited to, a system-on-chip (SoC), meter interface units 1702a-1702c, remote devices 1704, metering devices (e.g., water meters, gas meters, electricity meters, etc.) a server, workstation, laptop, mobile device, smartphone, tablet computer, mainframe, distributed computing system, compute cluster, media device, camera, gaming device, a portable digital assistant (PDA), a pager, a television, a wearable device, a virtual machine (VM), container, or any other device with processing capabilities. In one embodiment, the device 1802 represents some or all of the components of meter interface units 1702a- 1702c and/or remote devices 1704. More generally, the computing system 1800 is configured to implement all systems, methods, apparatuses, media, and embodiments disclosed herein.

As shown, the device 1802 includes one or more processors 1804, one or more memories 1806, one or more non-transitory storage media 1810, one or more communications interfaces 1812, one or more positioning devices 1814, one or more input devices 1816, and one or more output devices 1818 communicably coupled via an interconnect 1808. A power source 1820, such as a power supply, battery, or any type of power source may provide power to the device 1802.

The processor 1804 represents any type of processing circuit. For example, the processor 1804 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1806 represents any computer readable medium to store data, code, or other information. The memory 1806 may include volatile memory, such as volatile Random Access Memory (RAM) including a cache area for the temporary storage of data. The memory 1806 may also include non-volatile memory, which can be embedded and/or may be removable. The non-volatile memory can additionally or alternatively include an electrically erasable programmable read-only memory (EEPROM), flash memory or the like. The storage medium 1810 represents any type of computer readable medium to store data, code, or other information. Examples of storage media 1810 include solid state drives, hard drives, Redundant Array of Independent Disks (RAID) drives, memory pools, universal serial bus (USB) storage devices, and the like.

The memory 1806 and storage medium 1810 can store any number and type of computer-executable instructions executed by the processor 1804 to implement the functions of the device 1802. For example, the memory 1806 may include instructions for processing commands received via microstrip antenna 302, microstrip antenna 502, and/or microstrip antenna 1402 and instructions for transmitting commands via microstrip antenna 302, microstrip antenna 502, and/or microstrip antenna 1402. For example, the instructions may include instructions to cause a metering device to perform an operation (e.g., to read, write, or otherwise modify a parameter of a metering device) based on a command received via microstrip antenna 302, microstrip antenna 502, and/or microstrip antenna 1402. As another example, the instructions may include instructions to receive data from a metering device (e.g., meter readings, consumption values, configurations, etc.) and transmit indications of the data to a remote device via microstrip antenna 302, microstrip antenna 502, and/or microstrip antenna 1402.

The interconnect 1808 represents any type of circuitry to connect the components of the device 1802. For example, the interconnect 1808 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1804 to the memory 1806, individual electrical connections among the components, and electrical conductive traces on a motherboard common to some or all of the above-described components of the device 1802. As discussed herein, the interconnect 1808 may operatively couple various components with one another, or in other words, electrically connects those components, either directly or indirectly – by way of intermediate component(s) - with one another.

The one or more input devices 1816 represent any type of input device for receiving input, such as a keypad, keyboard, touchscreen, touchpad, microphone, camera, fingerprint sensor, mouse, joystick, other pointer device, button, soft key, and the like. The one or more output devices 1818 represent any type of device for outputting information, such as a cable, monitor, speaker, haptic feedback module, printer, and the like.

The device 1802 may use the communications interface 1812 to communicate with one or more other devices 1824 via a network 1822. The communications interface 1812 allows the device 1802 to communicate with and conduct transactions with other devices and systems, such as the other devices 1824. The communications interface 1812 may be a wired and/or a wireless interface. Communications may be conducted via various modes or protocols, of which Global System for Mobile Communications (GSM) voice calls, Short Message Service (SMS), Enhanced Messaging Service (EMS), Multimedia Messaging Service (MMS) messaging, Time Division Multiple Access (TDMA), Code Division Multiple Access (CDMA), Personal Digital Cellular (PDC), Wideband Code Division Multiple Access (WCDMA), CDMA2000, and General Packet Radio Service (GPRS), are all non-limiting and non-exclusive examples. Thus, communications can be conducted, for example, via the wireless communications interface 1812, which can be or include a radio-frequency transceiver, a Bluetooth device, Wi-Fi device, a Near-Field Communication (NFC) device, and other wireless transceivers. In addition, a positioning device 1814 such as a Global Positioning System (GPS) device may be included for navigation and location-related data exchanges, ingoing and/or outgoing. Wi-Fi networks use radio technologies such as the Institute of Electrical and Electronics Engineers (IEEE) 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). Communications may also and/or alternatively be conducted via wired connections using the communications interface 1812, e.g., using USB, Ethernet, and other physically connected modes of data transfer. The network 1822 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a Long Range (LoRa) network, a wireless network, a cellular network, and other communications networks.

The device 1802 is configured to use the communications interface 1812 as, for example, a network interface to communicate with one or more other devices on a network such as network 1822. In this regard, the device 1802 utilizes the wireless communications interface 1812 as an antenna operatively coupled to a transmitter and a receiver (together a “transceiver”) included with the communications interface 1812. The communications interface 1812 may include one or more of the microstrip antenna 302, microstrip antenna 502, and/or the microstrip antenna 1402. As another example, the communications interface 1812 is representative of the communications interface 1712. In some embodiments, communications interface 1812 is configured to provide signals to and receive signals from the transmitter and receiver, respectively. The signals may include signaling information in accordance with the air interface standard of the applicable cellular system of a wireless telephone network. In this regard, the device 1802 may be configured to operate with one or more air interface standards, communication protocols, modulation types, and access types. By way of illustration, the device 1802 may be configured to operate in accordance with any of a number of first, second, third, fourth, fifth-generation communication protocols and/or the like. For example, as a smartphone, the device 1802 may be configured to operate in accordance with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The device 1802 may also be configured to operate in accordance with non-cellular communication mechanisms, such as via a wireless local area network (WLAN) or other communication/data networks.

The device 1802 may be under the control of any suitable operating system (not pictured). Example operating systems include, but are not limited to, Linux® operating systems, UNIX®, Windows® operating systems, macOS®, iOS®, Android®, and any other type of operating system.

The device 1802 as illustrated diagrammatically represents at least one example of a possible implementation, where alternatives, additions, and modifications are possible for performing some or all of the described methods, operations, and functions. Although shown separately, in some embodiments, two or more devices 1802, systems, servers, or illustrated components may be utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Example 1 includes a microstrip patch antenna, comprising: a substrate having a first surface and a second surface; a microstrip patch coupled with the first surface of the substrate, a metal foil comprising a pair of slots and a perimeter slot; and a ground plane coupled with the second surface of the substrate.

Example 2 includes the subject matter of example 1, wherein the slots are etched into the microstrip patch to create voids in the microstrip patch, wherein a shape of the antenna is circular.

Example 3 includes the subject matter of any preceding example, wherein the perimeter slot is within a first hemisphere the antenna, wherein the pair of slots are within a second hemisphere of the antenna.

Example 4 includes the subject matter of any preceding example, further comprising: a feeding point connected to the microstrip patch; and a coaxial cable coupled to the feeding point via the substrate, a ground of the feeding point connected to the ground plane.

Example 5 includes the subject matter of any preceding example, wherein an angle formed by a first line through the perimeter slot and a second line between the pair of slots is based on a predetermined resonant frequency for the antenna.

Example 6 includes the subject matter of any preceding example, wherein the pair of slots comprise an E-slot.

Example 7 includes the subject matter of any preceding example, wherein lengths and widths of each slot of the pair of slots are equal.

Example 8 includes the subject matter of any preceding example, wherein lengths and widths of each slot of the pair of slots are unequal.

Example 9 includes the subject matter of any preceding example, wherein dimensions of the perimeter slot define a bandwidth of the antenna, wherein the pair of slots shift the bandwidth of the antenna to be within a predetermined range of frequencies.

Example 10 includes the subject matter of any preceding example, wherein the antenna is configured to exhibit resonance at a first frequency within the predetermined range of frequencies and at a second frequency within the predetermined range of frequencies.

Example 11 includes the subject matter of any preceding example, wherein the predetermined range of frequencies is approximately 902 MHz to 928 MHz, supporting Long Range (LoRa) wireless communications.

Example 12 includes the subject matter of any preceding example, wherein the dimensions of the perimeter slot comprise: (i) a width of approximately 17-19 millimeters, (ii)

a length of approximately 10-12 millimeters, wherein the dimensions of a first slot of the pair of slots comprises: (i) a width of approximately 15-17 millimeters, (ii) a length of approximately 9-11 millimeters, wherein the dimensions of a second slot of the pair of slots comprises: (i) a width of approximately 13-15 millimeters, (ii) a length of approximately 12-14 millimeters, wherein a distance between the pair of slots is approximately 42-46 millimeters, wherein an angle formed between a line between the pair of slots and a line through the perimeter slot is approximately 123-125 degrees, wherein a radius of the antenna is approximately 49 millimeters, wherein the substrate is approximately 6 millimeters thick, wherein the microstrip patch is approximately 2.3 millimeters thick, wherein a dielectric constant of the substrate is 3.5.

Example 13 includes the subject matter of any preceding example wherein the dimensions of the perimeter slot comprise: (i) a width of approximately 12-14 millimeters, (ii) a length of approximately 18-20 millimeters, wherein the dimensions of each slot of the pair of slots comprises: (i) a width of approximately 7-9 millimeters, (ii) a length of approximately 30-33 millimeters, wherein a distance between the pair of slots is approximately 65-67 millimeters, wherein an angle formed between a line between the pair of slots and a line through the perimeter slot is approximately 116-118 degrees, wherein a radius of the antenna is approximately 49 millimeters, wherein the substrate is approximately 6 millimeters thick, wherein the microstrip patch is approximately 2.3 millimeters thick, wherein a dielectric constant of the substrate is 3.5.

Example 14 includes the subject matter of any preceding example, wherein the predetermined range of frequencies is approximately 2.4 GHz to 2.485 GHz, supporting Bluetooth communication.

Example 15 includes the subject matter of any preceding example, wherein the dimensions of the perimeter slot comprise: (i) a width of approximately 6-8 millimeters, (ii) a length of approximately 2-4 millimeters, wherein the dimensions of each slot of the pair of slots comprises: (i) a width of approximately 4-16 millimeters, (ii) a length of approximately 2-4 millimeters, wherein a distance between the pair of slots is approximately 27-29 millimeters, wherein an angle formed between a line between the pair of slots and a line through the perimeter slot is approximately 149-151 degrees, wherein a radius of the antenna is approximately 18 millimeters, wherein the substrate is approximately 2.3 millimeters thick,

wherein the microstrip patch is approximately 2.3 millimeters thick, wherein a dielectric constant of the substrate is 3.5.

Example 16 includes the subject matter of any preceding example, wherein the slots extend from an edge of the metal foil, wherein the slots do not protrude into the substrate.

Example 17 includes the subject matter of any preceding example, wherein the antenna is configured to: receive a signal from a meter interface unit; and transmit the signal to another device.

Example 18 includes the subject matter of any preceding example, wherein the antenna is configured to: receive a signal from another device; and transmit the signal to a meter interface unit.

Example 19 includes the subject matter of any preceding example, wherein a base of each of the slots is defined by the first surface, wherein a depth of the slots are defined by a thickness of the microstrip patch.

Example 20 includes a method of manufacturing a microstrip antenna, the method comprising: providing a substrate having a first surface and a second surface; providing a microstrip patch comprising a pair of slots and a perimeter slot, wherein a base of the slots are defined by the first surface, wherein a depth of the slots are defined by a thickness of the microstrip patch; and coupling: (i) the microstrip patch to the first surface of the substrate, and (ii) a ground plane to the second surface of the substrate.

Example 21 includes an apparatus, comprising: a processor; and a microstrip patch antenna, comprising: a substrate having a first surface and a second surface; a microstrip patch coupled with the first surface of the substrate, the microstrip patch comprising a pair of slots and a perimeter slot; and a ground plane coupled with the second surface of the substrate.

Example 22 includes a microstrip patch antenna, comprising: a substrate having a first surface and a second surface; a microstrip patch coupled with the first surface of the substrate, the microstrip patch comprising a pair of slots and a perimeter slot; and a ground plane coupled with the second surface of the substrate.

Example 23 includes the subject matter of any preceding example, wherein the slots are etched into the microstrip patch to create voids in the microstrip patch, wherein a shape of the antenna is circular.

Example 24 includes the subject matter of any preceding example, wherein the perimeter slot is within a first hemisphere the antenna, wherein the pair of slots are within a second hemisphere of the antenna.

Example 25 includes the subject matter of any preceding example, further comprising: a feeding point connected to the microstrip patch; and a coaxial cable coupled to the feeding point via the substrate, a ground of the feeding point connected to the ground plane.

Example 26 includes the subject matter of any preceding example, wherein an angle formed by a first line through the perimeter slot and a second line between the pair of slots is based on a predetermined resonant frequency for the antenna.

Example 27 includes the subject matter of any preceding example, wherein the pair of slots comprise an E-slot.

Example 28 includes the subject matter of any preceding example, wherein lengths and widths of each slot of the pair of slots are equal.

Example 29 includes the subject matter of any preceding example, wherein lengths and widths of each slot of the pair of slots are unequal.

Example 30 includes the subject matter of any preceding example, wherein dimensions of the perimeter slot define a bandwidth of the antenna, wherein the pair of slots shift the bandwidth of the antenna to be within a predetermined range of frequencies.

Example 31 includes the subject matter of any preceding example, wherein the antenna is configured to exhibit resonance at a first frequency within the predetermined range of frequencies and at a second frequency within the predetermined range of frequencies.

Example 32 includes the subject matter of any preceding example, wherein the predetermined range of frequencies is approximately 902 MHz to 928 MHz, supporting Long Range (LoRa) wireless communications.

Example 33 includes the subject matter of any preceding example, wherein the dimensions of the perimeter slot comprise: (i) a width of approximately 17-19 millimeters, (ii) a length of approximately 10-12 millimeters, wherein the dimensions of a first slot of the pair of slots comprises: (i) a width of approximately 15-17 millimeters, (ii) a length of approximately 9-11 millimeters, wherein the dimensions of a second slot of the pair of slots comprises: (i) a width of approximately 13-15 millimeters, (ii) a length of approximately 12-14 millimeters, wherein a distance between the pair of slots is approximately 42-46 millimeters,

wherein an angle formed between a line between the pair of slots and a line through the perimeter slot is approximately 123-125 degrees, wherein a radius of the antenna is approximately 49 millimeters, wherein the substrate is approximately 6 millimeters thick, wherein the microstrip patch is approximately 2.3 millimeters thick, wherein a dielectric constant of the substrate is 3.5.

Example 34 includes the subject matter of any preceding example, wherein the dimensions of the perimeter slot comprise: (i) a width of approximately 12-14 millimeters, (ii) a length of approximately 18-20 millimeters, wherein the dimensions of each slot of the pair of slots comprises: (i) a width of approximately 7-9 millimeters, (ii) a length of approximately 30-33 millimeters, wherein a distance between the pair of slots is approximately 65-67 millimeters, wherein an angle formed between a line between the pair of slots and a line through the perimeter slot is approximately 116-118 degrees, wherein a radius of the antenna is approximately 49 millimeters, wherein the substrate is approximately 6 millimeters thick, wherein the microstrip patch is approximately 2.3 millimeters thick, wherein a dielectric constant of the substrate is 3.5.

Example 35 includes the subject matter of any preceding example, wherein the predetermined range of frequencies is approximately 2.4 GHz to 2.485 GHz, supporting Bluetooth communication.

Example 36 includes the subject matter of any preceding example, wherein the dimensions of the perimeter slot comprise: (i) a width of approximately 6-8 millimeters, (ii) a length of approximately 2-4 millimeters, wherein the dimensions of each slot of the pair of slots comprises: (i) a width of approximately 4-16 millimeters, (ii) a length of approximately 2-4 millimeters, wherein a distance between the pair of slots is approximately 27-29 millimeters, wherein an angle formed between a line between the pair of slots and a line through the perimeter slot is approximately 149-151 degrees, wherein a radius of the antenna is approximately 18 millimeters, wherein the substrate is approximately 2.3 millimeters thick, wherein the microstrip patch is approximately 2.3 millimeters thick, wherein a dielectric constant of the substrate is 3.5.

Example 37 includes the subject matter of any preceding example, wherein the microstrip patch comprises a metal foil or a plated conductive layer, wherein the slots extend from an edge of the microstrip patch, wherein the slots do not protrude into the substrate.

Example 38 includes the subject matter of any preceding example, wherein the antenna is configured to: receive a signal from a meter interface unit; and transmit the signal to another device.

Example 39 includes the subject matter of any preceding example, wherein the antenna is configured to: receive a signal from another device; and transmit the signal to a meter interface unit.

Example 40 includes the subject matter of any preceding example, wherein a base of each of the slots is defined by the first surface, wherein a depth of the slots are defined by a thickness of the microstrip patch.

Example 41 includes a method of manufacturing a microstrip patch antenna, the method comprising: providing a substrate having a first surface and a second surface; providing a microstrip patch comprising a pair of slots and a perimeter slot, wherein a base of the slots are defined by the first surface, wherein a depth of the slots are defined by a thickness of the microstrip patch; and coupling: (i) the microstrip patch to the first surface of the substrate, and (ii) a ground plane to the second surface of the substrate.

Example 42 includes an apparatus, comprising: a processor; and a microstrip patch antenna, comprising: a substrate having a first surface and a second surface; a microstrip patch coupled with the first surface of the substrate, the microstrip patch comprising a pair of slots and a perimeter slot; and a ground plane coupled with the second surface of the substrate.

Example 43 includes the subject matter of any preceding example, wherein dimensions of the perimeter slot define a bandwidth of the antenna, wherein the pair of slots shift the bandwidth of the antenna to be within a predetermined range of frequencies, wherein the predetermined range of frequencies is approximately 902 MHz to 928 MHz, supporting Long Range (LoRa) wireless communications.

Example 44 includes the subject matter of any preceding example, wherein the dimensions of the perimeter slot comprise: (i) a width of approximately 17-19 millimeters, (ii) a length of approximately 10-12 millimeters, wherein the dimensions of a first slot of the pair of slots comprises: (i) a width of approximately 15-17 millimeters, (ii) a length of approximately 9-11 millimeters, wherein the dimensions of a second slot of the pair of slots comprises: (i) a width of approximately 13-15 millimeters, (ii) a length of approximately 12-14 millimeters, wherein a distance between the pair of slots is approximately 42-46 millimeters, wherein an angle formed between a line between the pair of slots and a line through the

perimeter slot is approximately 123-125 degrees, wherein a radius of the antenna is approximately 49 millimeters, wherein the substrate is approximately 6 millimeters thick, wherein the microstrip patch is approximately 2.3 millimeters thick, wherein a dielectric constant of the substrate is 3.5.

Example 45 includes an apparatus comprising the microstrip patch antenna of any preceding example.

Example 46 includes an apparatus, comprising: an interface to a metering device, and the microstrip patch antenna of any preceding example.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A microstrip patch antenna, comprising:
a substrate having a first surface and a second surface;
a microstrip patch coupled with the first surface of the substrate, the microstrip patch comprising a pair of slots and a perimeter slot; and
a ground plane coupled with the second surface of the substrate.

2. The microstrip patch antenna of claim 1, wherein the slots are etched into the microstrip patch to create voids in the microstrip patch, wherein a shape of the antenna is circular.

3. The microstrip patch antenna of claim 2, wherein the perimeter slot is within a first hemisphere the antenna, wherein the pair of slots are within a second hemisphere of the antenna.

4. The microstrip patch antenna of claim 1, further comprising:
a feeding point connected to the microstrip patch; and
a coaxial cable coupled to the feeding point via the substrate, a ground of the feeding point connected to the ground plane.

5. The microstrip patch antenna of claim 4, wherein an angle formed by a first line through the perimeter slot and a second line between the pair of slots is based on a predetermined resonant frequency for the antenna.

6. The microstrip patch antenna of claim 1, wherein the pair of slots comprise an E-slot.

7. The microstrip patch antenna of claim 6, wherein lengths and widths of each slot of the pair of slots are equal.

8. The microstrip patch antenna of claim 6, wherein lengths and widths of each slot of the pair of slots are unequal.

9. The microstrip patch antenna of claim 1, wherein dimensions of the perimeter slot define a bandwidth of the antenna, wherein the pair of slots shift the bandwidth of the antenna to be within a predetermined range of frequencies.

10. The microstrip patch antenna of claim 9, wherein the antenna is configured to exhibit resonance at a first frequency within the predetermined range of frequencies and at a second frequency within the predetermined range of frequencies.

11. The microstrip patch antenna of claim 9, wherein the predetermined range of frequencies is approximately 902 MHz to 928 MHz, supporting Long Range (LoRa) wireless communications.

12. The microstrip patch antenna of claim 11, wherein the dimensions of the perimeter slot comprise: (i) a width of approximately 17-19 millimeters, (ii) a length of approximately 10-12 millimeters, wherein the dimensions of a first slot of the pair of slots comprises: (i) a width of approximately 15-17 millimeters, (ii) a length of approximately 9-11 millimeters, wherein the dimensions of a second slot of the pair of slots comprises: (i) a width of approximately 13-15 millimeters, (ii) a length of approximately 12-14 millimeters, wherein a distance between the pair of slots is approximately 42-46 millimeters, wherein an angle formed between a line between the pair of slots and a line through the perimeter slot is approximately 123-125 degrees, wherein a radius of the antenna is approximately 49 millimeters, wherein the substrate is approximately 6 millimeters thick, wherein the microstrip patch is approximately 2.3 millimeters thick, wherein a dielectric constant of the substrate is 3.5.

13. The microstrip patch antenna of claim 1, wherein the microstrip patch comprises a metal foil or a plated conductive layer, wherein the slots extend from an edge of the microstrip patch, wherein the slots do not protrude into the substrate.

14. The microstrip patch antenna of claim 1, wherein the antenna is configured to:
receive a signal from a meter interface unit; and
transmit the signal to another device.

15. The microstrip patch antenna of claim 1, wherein the antenna is configured to:
receive a signal from another device; and
transmit the signal to a meter interface unit.

16. The microstrip patch antenna of claim 1, wherein a base of each of the slots is defined by the first surface, wherein a depth of the slots are defined by a thickness of the microstrip patch.

17. A method of manufacturing a microstrip patch antenna, the method comprising:
providing a substrate having a first surface and a second surface;
providing a microstrip patch comprising a pair of slots and a perimeter slot, wherein a base of the slots are defined by the first surface, wherein a depth of the slots are defined by a thickness of the microstrip patch; and
coupling: (i) the microstrip patch to the first surface of the substrate, and (ii) a ground plane to the second surface of the substrate.

18. An apparatus, comprising:
a processor; and
a microstrip patch antenna, comprising:
a substrate having a first surface and a second surface;
a microstrip patch coupled with the first surface of the substrate, the microstrip patch comprising a pair of slots and a perimeter slot; and
a ground plane coupled with the second surface of the substrate.

19. The apparatus of claim 18, wherein dimensions of the perimeter slot define a bandwidth of the antenna, wherein the pair of slots shift the bandwidth of the antenna to be within a predetermined range of frequencies, wherein the predetermined range of frequencies is approximately 902 MHz to 928 MHz, supporting Long Range (LoRa) wireless communications.

20. The apparatus of claim 19, wherein the dimensions of the perimeter slot comprise: (i) a width of approximately 17-19 millimeters, (ii) a length of approximately 10-12 millimeters, wherein the dimensions of a first slot of the pair of slots comprises: (i) a width of approximately 15-17 millimeters, (ii) a length of approximately 9-11 millimeters, wherein the dimensions of a second slot of the pair of slots comprises: (i) a width of approximately 13-15 millimeters, (ii) a length of approximately 12-14 millimeters, wherein a distance between the pair of slots is approximately 42-46 millimeters, wherein an angle formed between a line between the pair of slots and a line through the perimeter slot is approximately 123-125 degrees, wherein a radius of the antenna is approximately 49 millimeters, wherein the substrate is approximately 6 millimeters thick, wherein the microstrip patch is approximately 2.3 millimeters thick, wherein a dielectric constant of the substrate is 3.5.
